(19) United States
(12) Patent Application Publication
(10) Pub. No.: US 2016/0364771 A1
(43) Pub. Date: Dec. 15, 2016

(54) METHODS, APPARATUS, AND SYSTEMS FOR SURVEILLANCE OF THIRD-PARTY DIGITAL TECHNOLOGY VENDORS PROVIDING SECONDARY CONTENT IN A CONTENT PUBLISHER'S WEB PAGE

(71) Applicant: GHOSTERY, INC., New York, NY (US)

(72) Inventors: Patrick M. Nielsen, Brooklyn, NY (US); Vern DeMille, Lehi, UT (US); Joseph C. Kilrain, Edison, NJ (US); Scott Meyer, Mount Kisco, NY (US); Justin Donohoo, Herriman, UT (US); Edward Kozek, New York, NY (US); Bree Van Oss, Tallahassee, FL (US); Jose Maria Signanini, New York, NY (US)

(73) Assignee: GHOSTERY, INC., New York, NY (US)

(21) Appl. No.: 15/059,296

(22) Filed: Mar. 2, 2016

Related U.S. Application Data
(63) Continuation-in-part of application No. 13/968,098, filed on Aug. 15, 2013.
(60) Provisional application No. 62/127,281, filed on Mar. 2, 2015.
(60) Provisional application No. 61/683,515, filed on Aug. 15, 2012.

(51) Int. Cl. G06Q 30/02; G06F 17/30

(52) U.S. Cl. CPC G06Q 30/0277; G06F 17/30887

(57) ABSTRACT

Analysis of an Internet content publisher's web pages to identify third-party vendor tags, as well as piggyback vendor tags called during execution of a given web page, that ultimately cause various types of secondary (“foreign”) content (e.g., ads, trackers, analytics, widgets, privacy assets) to be present in the content publisher's web pages when rendered by a browser on a client computing device. Such analysis also reveals the sources of the tags and the foreign content, and parent-child relationships (“parentage”) amongst vendor tags. A graphical representation is then rendered that includes one or more visualizations of the identified vendor tags, and the corresponding sources of the tags and the foreign content in the content publisher's web pages, as well as other information relating to the tags, the foreign content and their sources (e.g., parentage, classification of content, timing of called tags, latency resulting from tags, secure/unsecure calls to foreign resources, etc.).

### CROSS-REFERENCES TO RELATED APPLICATIONS

The present application claims a priority benefit, under 35 U.S.C. §119(e), to U.S. provisional application Ser. No. 62/127,281, filed Mar. 2, 2015, entitled “Methods, Apparatus, and Systems for Surveillance of Third-party Digital Technology Vendors in a Web Domain.”

The present application also claims a priority benefit, under 35 U.S.C. §120, as a continuation-in-part (CIP) of U.S. non-provisional application Ser. No. 13/968,098, filed Aug. 15, 2013, entitled “Systems and Methods for Discovering Sources of Online Content.”

Ser. No. 13/968,098 in turn claims a priority benefit to U.S. provisional application Ser. No. 61/683,515, filed Aug. 15, 2012, entitled “Systems and Methods for Discovering Sources of Online Content.”

Each of the foregoing applications is incorporated by reference herein in its entirety.

### BACKGROUND

Most enterprises are not fully aware of the vendors in their marketing cloud and certainly do not manage those vendors through a centralized process. In most cases, an enterprise's marketing cloud develops through a wide network of individuals, departments, and agencies that have access to the website across marketing, IT, e-commerce, analytics and operations.

Content displayed on a web page, while seemingly a cohesive collection of text, images and multimedia, is in fact a collection of often unrelated content cobbled together just prior to its display. While the primary content on a web page (e.g., an article, game screen, or video) may be specific to the URL entered by the user, the rest of the page (often referred to as advertising real estate) is essentially left blank by the content provider. The primary content provider then allows other “third-party” vendors to identify and serve the “secondary” content. This secondary content usually includes visible and non-visible web page elements and resources.

In the simplest form, an Internet content publisher (also referred to herein as an “enterprise”) contracts with a single entity, for example, a contracted third-party digital technology vendor, to provide web page elements (also referred to as “tags”) into their web site pages. In this scenario the web page elements are managed by only the contracted third-party digital vendor. However, this singular relationship is rarely the case. In practice, content publishers utilize numerous networks of third-party digital vendors; consequently a web site may retrieve web page elements and web resources from multiple sources, including elements and resources from additional third-party digital vendor networks not contracted directly by the content publisher. This situation creates a multi-tiered collection of web page elements and web resources which can be far removed from the contracted third-party digital vendors and the content publisher.

Additionally, as digital behavior grows and deepens, Internet content publishers are tasked with creating customer databases, growing online ecommerce capabilities and improving customer experiences. All of these goals are compromised by poor marketing cloud management. Without control, content publishers/web site curators are exposed to gaping risks, such as customer data leaked to competitors, diluted data assets, web site latency, web site security breaches, and management inefficiency.

### SUMMARY

In view of the foregoing, various inventive embodiments disclosed herein are directed generally to analysis of an Internet content publisher's web pages to identify third-party vendor tags, as well as piggyback vendor tags called during execution of a given web page, that ultimately cause various types of secondary (“foreign”) content (e.g., ads, trackers, analytics, widgets, privacy assets) to be present in the content publisher's web pages when rendered by a browser on a client computing device. Such analysis also reveals the sources of the tags and the foreign content, and parent-child relationships (“parentage”) amongst vendor tags. A graphical representation is then rendered that includes one or more visualizations of the identified vendor tags, and the corresponding sources of the tags and the foreign content in the content publisher's web pages, as well as other information relating to the tags, the foreign content and their sources (e.g., parentage, classification of content, timing of called tags, latency resulting from tags, secure/unsecure calls to foreign resources, whitelisted/blacklisted sources, etc.).

More specifically, in one exemplary implementation a “web site surveillance” server provides a “Software-as-a-Service” (SaaS) application via a web portal to an enterprise client/content publisher, who invokes the SaaS application to analyze the content publisher's web pages. Via the web portal, the server then provides display-related data that to facilitate rendering of a graphical user interface (GUI) that includes a visualization (also referred to as a “tracker map”) of the tags and sources of tags/foreign content in the content publisher's web pages, as well as user functions and other information relating to the tags/foreign content and its sources.

In one embodiment, the analytics performed on the server pursuant to execution of the SaaS application utilize a digital vendor database having particular contents and structure relating to known third-party digital technology vendors, known vendor tags, and known patterns in known URL web addresses that respectively correspond to the known vendor tags. Pursuant to the SaaS application, the server executes a given web page of the enterprise client/content publisher's web site and maintains (e.g., stores in memory at the server or elsewhere) a request archive of all calls (HTTP requests) made from the web page during execution by a browser. The calls may be made by “resident” vendor tags in the original web page content received from the content publisher, as well as piggyback vendor tags that are retrieved and executed in response to a call made by a resident vendor tag or an earlier piggyback vendor tag.

Pursuant to archiving of calls made during execution of the web page, the server processes respective entries in the request archive to identify a “parentage” of all vendor tags (parent/child relationships) corresponding to the calls made during execution of the web page. The server further processes respective entries of the request archive, based on the known third-party digital technology vendors, known vendor tags, and known patterns in known URL web addresses in the digital vendor database, to identify piggyback vendor tags and foreign resources retrieved by the calls, and third-party vendor sources of tags and resources.

With respect to rendering of a GUI/graphical representation to visualize third-party vendor tags in an Internet content publisher's web pages, as well as piggyback vendor tags called during execution of a given web page, in one exemplary implementation the GUI/graphical representation (“tracker map”) includes identifiers or “nodes” for the corresponding sources of the vendor tags and the foreign content in the content publisher's web pages, as well as other information relating to the tags, the foreign content and their sources (e.g., parentage, classification of content, latency resulting from tags, secure/unsecure calls to obtain foreign content, new tags that appear over time, etc.).

For example, in a “balls and sticks” type tracker map graphical representation, the graphical representation may include a host web domain identifier in the form of a circular node (or “ball”) representing a host web domain for the Internet content publisher's web site, as well as a number of vendor tag domain identifiers in the form of circular balls and respectively representing corresponding foreign web domains that provide vendor tags. The graphical representation also may include a number of connectors (e.g., arrows or lines, or “sticks”) to interconnect the host domain identifier to one or more vendor tag domain identifiers, and various ones of the vendor tag domain identifiers to other vendor tag domain identifiers. In one aspect, such connectors represent a parental lineage (“parent-child” relationship) of the interconnected domain identifiers. The graphical representation also may include a number of third-party vendor identifiers, graphically associated with the vendor tag domain identifiers and representing the third-party digital technology vendors that provide vendor tags from foreign domains.

In other illustrative aspects of a graphical representation, respective sizes of the circular nodes for the vendor tag domain identifiers may indicate respective prevalence (i.e., call frequencies) of one or more vendor tags called during execution of the at least one web page. Similarly, respective colors of the vendor tag domain identifiers may represent respective classifications of vendor tags (e.g., ads, trackers, analytics, widgets, privacy assets) called during execution of the at least one web page. In another aspect, respective thicknesses of the connectors may represent an amount (or volume) of communication between respective domains represented by interconnected nodes (e.g., between the host domain and one foreign web domain, or between two foreign web domains, represented by interconnected domain identifiers). Other illustrative aspects of the graphical representation (e.g., using different colors, shapes, shading, hatching, outlines, and/or transparency for the nodes, and/or different colors, thicknesses or line-types for connectors) may indicate one or more of tag latency, tag security (e.g., unsecured v. secured calls), and evolution of tag presence (e.g., if a new tag appears on the web page at a certain time).

In different implementations, the processing of the web page by the server to facilitate rendering of a graphical representation may occur “live” in essentially real time, or web pages may be processed/scanned daily or weekly, or with some other periodicity (e.g., to observe trends and/or aggregate vendor tag information/activity over some time period). In some implementations, the analytics performed by a web site surveillance server involves execution of one or more of a content publisher's web pages using Google Chrome™ DevTools (e.g., a remote debugging interaction protocol of Google Chrome™ DevTools), and monitoring of messages generated during execution of the at least one web page that relate to the HTTP requests and respective responses to the HTTP requests (wherein some of the messages may correspond to a JavaScript call stack). In one exemplary implementation, the server formats such messages as time-stamped data objects, and stores the data objects in an archive for further processing to determine parentage (in some instances based on a JavaScript initiator URL), tag identity, and vendor identity.

In sum, one embodiment is directed to a web site surveillance apparatus (100) to reveal and monitor a plurality of third-party digital technology vendors (500A, 500B) providing foreign content on a client computing device (200) pursuant to execution of at least one web page (304) of a web site (302) by a browser (210) operating on the client computing device. The apparatus comprises: at least one communication interface (102) to communicatively couple the apparatus, via the Internet (600), to a host web domain (300) hosting the web site (302), a plurality of foreign web domains (400A, 400B) respectively associated with the plurality of third-party vendors, and a query computing device (600); at least one memory (106) storing processor-executable instructions (110); and at least one processor (108), communicatively coupled to the at least one communication interface and the at least one memory. Upon execution of the processor-executable instructions by the at least one processor, the at least one processor: A) controls the at least one communication interface to: A1) receive a query from the query computing device, wherein the query identifies the host web domain; and A2) in response to the query, retrieve (720) from the host web domain the at least one web page of the web site; B) analyzes the retrieved at least one web page to identify (740) a plurality of vendor tags (306A, 306B) in the at least one web page, wherein the plurality of vendor tags respectively include a corresponding redirection command (308A, 308B), and wherein each corresponding redirection command includes a Uniform Resource Locator (URL) web address (310A, 310B) to call at least one corresponding foreign web resource (402A, 402B) in at least one of the plurality of foreign web domains; C) identifies (760) the plurality of third-party vendors respectively associated with the plurality of vendor tags in the at least one web page and a plurality of piggyback vendor tags associated with the plurality of vendor tags in the at least one web page, based on at least one of: the URL web address included in each corresponding redirection command; and the at least one corresponding foreign web resource called by, or retrieved in response to, each corresponding redirection command; and D) controls the at least one communication interface to transmit, via the Internet to the query computing device (600), display-related data representing a graphical representation (1000) of the host web domain, the plurality of vendor tags identified in the at least one web page, and the plurality of piggyback vendor tags associated with the plurality of vendor tags wherein, upon processing the display-related data to render the graphical representation, the graphical representation includes: a host web domain identifier (1002) representing the host web domain; a plurality of vendor tag identifiers (1004A, 1004B) representing the plurality of vendor tags identified in the at least one web page and the plurality of piggyback vendor tags; and a plurality of third-party vendor identifiers (1006A, 1006B), graphically associated with the plurality of vendor tag identifiers and representing the plurality of third-party vendors respectively associated with the plurality of vendor tags identified in the at least one web page and the plurality of piggyback vendor tags.

Another embodiment is directed to a web site surveillance apparatus to reveal and monitor a plurality of third-party digital technology vendors providing foreign content on a client computing device pursuant to execution of at least one web page of a web site by a browser operating on the client computing device. The apparatus comprises: at least one communication interface to communicatively couple the apparatus, via the Internet, to a host web domain hosting the web site and a plurality of foreign web domains respectively associated with the plurality of third-party vendors; at least one user interface including a display device; at least one memory storing processor-executable instructions; and at least one processor, communicatively coupled to the at least one communication interface, the at least one user interface, and the at least one memory. Upon execution of the processor-executable instructions by the at least one processor, the at least one processor: A) controls the at least one communication interface to retrieve from the host web domain the at least one web page of the web site; B) analyzes the retrieved at least one web page to identify a first vendor tag in the at least one web page that includes a first redirection command, wherein the first redirection command includes a first Uniform Resource Locator (URL) web address to call at least one first foreign web resource in at least one of the plurality of foreign web domains; C) executes the first redirection command and thereby controls the at least one communication interface to retrieve the first foreign web resource based on the first URL web address, wherein: the first foreign web resource includes an additional redirection command; and the additional redirection command includes an additional URL web address to call at least one additional foreign web resource in at least one of the plurality of foreign web domains; D) identifies a first third-party vendor of the plurality of third-party vendors and associated with the first vendor tag based on at least one of the first URL web address included in the first redirection command and the first foreign web resource; E) executes the additional redirection command in the first foreign web resource and thereby controls the at least one communication interface to retrieve the additional foreign web resource based on the additional URL web address; and F) identifies an additional third-party vendor of the plurality of third-party vendors based on at least one of the additional URL web address included in the additional redirection command and the additional foreign web resource.

Another embodiment is directed to a system for analyzing respective web pages of an Internet content publisher's web site to identify a plurality of third-party vendor tags that cause foreign content to be present in at least one web page of the web site when rendered by a browser executing on a client computing device. The system comprises: at least one communication interface to communicatively couple the system, via the Internet, to at least a host web domain hosting the web site, a plurality of foreign web domains respectively associated with a plurality of third-party vendors, and a query computing device; at least one memory storing processor-executable instructions and a digital vendor database, the digital vendor database comprising: a plurality of known vendor entries respectively corresponding to a plurality of known third-party digital technology vendors; a plurality of known tag entries respectively corresponding to a plurality of known vendor tags; and a plurality of known URL pattern entries respectively corresponding to a plurality of known patterns in known URL web addresses that respectively correspond to the plurality of known vendor tags; and at least one processor, communicatively coupled to the at least one communication interface and the at least one memory. Upon execution of the processor-executable instructions by the at least one processor, the at least one processor: A) controls the at least one communication interface to: A1) receive a query from the query computing device, wherein the query identifies the host web domain; and A2) in response to the query, retrieve from the host web domain the at least one web page of the web site; B) executes the at least one web page to determine a plurality of Hypertext Transfer Protocol (HTTP) requests made during execution of the at least one web page, each HTTP request corresponding to one vendor tag of the plurality of third-party vendor tags; C) stores in the at least one memory a request archive that includes respective request archive entries corresponding to the plurality of HTTP requests made in B); D) processes the respective request archive entries in the request archive to determine a parentage for each vendor tag of the plurality of third-party vendor tags; E) processes the respective request archive entries in the request archive to identify the plurality of vendor tags and a plurality of third-party digital technology vendors corresponding to the plurality of vendor tags, based at least in part on the plurality of known vendor entries, the plurality of known tag entries, and the plurality of known URL pattern entries in the digital vendor database; and F) controls the at least one communication interface to transmit, via the Internet to the query computing device, data representing: the plurality of vendor tags determined in E); the plurality of third-party digital technology vendors determined in E); and the parentage determined in D) for each vendor tag of the plurality of vendor tags.

Another embodiment is directed to a computer-facilitated method for rendering a graphical representation, on at least one display device, of a plurality of third-party vendor tags associated with an Internet content publisher's web site, wherein the plurality of vendor tags cause foreign content to be present in respective web pages of the content publisher's web site when executed by a browser. The method comprises: A) electronically analyzing at least one web page of the web site to identify at least some of the plurality of vendor tags associated with the at least one web page, the at least some of the plurality of vendor tags including a first plurality of resident vendor tags in the at least one web page, and a second plurality of piggyback vendor tags called during execution of the at least one web page; B) determining a parentage for each vendor tag of the at least some of the plurality of vendor tags associated with the at least one web page; C) determining a plurality of third-party digital technology vendors corresponding to the at least some of plurality of vendor tags; D) generating display-related data based on the at least some of the plurality of vendor tags identified in A), the parentage determined in B) for each vendor tag, and the plurality of third-party digital technology vendors determined in C); and E) transmitting, to the at least one display device, the display-related data generated in D) to facilitate rendering the graphical representation on the at least one display device, wherein the display-related data includes respective data elements such that upon rendering the graphical representation, the graphical representation comprises: a host web domain identifier representing a host web domain for the Internet content publisher's web site; a plurality of vendor tag domain identifiers respectively representing corresponding foreign web domains that provide the at least some of the plurality of vendor tags; a plurality of connectors to interconnect the plurality of vendor tag domain identifiers, each connector of the plurality of connectors representing the parentage of one vendor tag provided by one foreign web domain represented by a corresponding one of the plurality of vendor tag domain identifiers coupled to the connector; and a plurality of third-party vendor identifiers, graphically associated with the plurality of vendor tag domain identifiers and representing the plurality of third-party digital technology vendors.

It should be appreciated that all combinations of the foregoing concepts in the published applications incorporated by reference herein and the attached appendices, as well as additional concepts discussed in greater detail below (provided such concepts are not mutually inconsistent), are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a high level view of a system for surveillance of third-party digital technology vendors in a web domain, according to one embodiment of the present invention.

FIG. 2 illustrates, an example of data structures in a web page including web elements, redirection commands, and uniform resource locaters (URL), according to one embodiment of the present invention.

FIG. 3 illustrates the front-end view of a web page and portion of the web page source code, according to one embodiment of the present invention.

FIG. 4 illustrates an example of a foreign web resource, according to one embodiment of the present invention.

FIG. 5 illustrates an example of a client computing device loading a web resource from a piggyback vendor, in one embodiment of the present invention.

FIG. 6 illustrates an example of a graphical representation of a chain of resources/events, in one embodiment of the present invention.

FIG. 7 illustrates a first flowchart representing part of the instructions executed by a web site surveillance apparatus, according to one embodiment of the present invention.

FIG. 8 illustrates a second flowchart representing part of the instructions executed by a web site surveillance apparatus, according to one embodiment of the present invention.

FIG. 9 illustrates a third flowchart representing part of the instructions executed by a website surveillance apparatus, according to one embodiment of the present invention.

FIG. 10 depicts aspects of a process executed from a client device to feed vendors data to a website surveillance system, according to one embodiment of the present invention.

FIG. 11 illustrates an example of foreign resources and parentage relationships that can be embedded in a web page or web domain.

FIG. 12A illustrates a portion of a user interface enabled by the website surveillance system, according to one embodiment of the invention.

FIG. 12B illustrates a portion of a user interface enabled by the website surveillance system, according to one embodiment of the invention.

FIG. 12C illustrates a portion of a user interface enabled by the website surveillance system, according to one embodiment of the invention.

FIG. 13 illustrates a tool bar to filter and view different aspects of a plurality of third party vendor chains associated with a web domain or web site according to one embodiment of the present invention.

FIG. 14 illustrate a graphical user interface featuring new tags associated with a web domain or website, according to one embodiment of the present invention.

FIG. 15 illustrates a graphical user interface featuring unsecure communications among domains associated with a web domain or website, according to one embodiment of the present invention.

FIG. 16 illustrates a graphical user interface featuring whitelist tags and new tags associated with a web domain or website, according to one embodiment of the present invention.

FIG. 17 illustrates a graphical user interface featuring blacklist tags and unsecure communications among domains associated with a web domain or website, according to one embodiment of the present invention.

FIG. 18 illustrates a graphical user interface featuring loading latency of vendor tags associated with a web domain or website, according to one embodiment of the present invention.

FIG. 19 illustrates a graphical user interface displaying time lines associated with the loading time of a plurality of tags associated with a web domain or website, according to one embodiment of the present invention.

FIG. 20 illustrates a graphical user interface displaying a tree view of a plurality of tags associated with a web domain or website, according to one embodiment of the present invention.

FIG. 21 illustrates a graphical user interface to create a black list alert, according to one embodiment of the present invention.

FIG. 22A illustrates a portion of a graphical user interface displaying statistical data and information associated with a web domain or website, according to one embodiment of the invention.

FIG. 22B illustrates a portion of a graphical user interface displaying statistical data and information associated with a web domain or website, according to one embodiment of the invention.

FIG. 23 illustrates a process to scan a web page to discover and display web resources associated with the web page, according to one embodiment of the present invention.

FIG. 24 illustrates a process to scan multiple domains to discover and display web resources associated with the multiple domains, according to one embodiment of the present invention.

The features and advantages of the present invention will become more apparent from the detailed description set forth below when taken in conjunction with the drawings.

### DETAILED DESCRIPTION

Following below are more detailed descriptions of various concepts related to, and embodiments of, inventive methods, apparatus and systems for surveillance of third-party digital technology vendors providing secondary content in one or more web pages of an Internet content publisher's web site. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

### GLOSSARY

Web domain: a realm of administrative autonomy, authority or control of computer resources within the Internet.

Web site: a set of related web pages typically served from a single “host” web domain. A web site is hosted on at least one web server in the host web domain and accessible via an Internet browser (an application resident on a client computing device). A given web page of a web site is accessed via an Internet address (or “web address”) used by the browser and known as a uniform resource locator (URL). A URL includes a compact sequence of characters identifying the host web domain and the location in the web domain at which a given web page resides (and from which it may be retrieved). The URLs of respective web pages of a web site organize the pages into a hierarchy; a typical web site generally includes a “home page” having a corresponding URL, and the home page typically contains hyperlinks to other web pages of the web site (which in turn have different corresponding URLs that are nonetheless related by a common web domain identifier in the URL).

Web pare: a “hypertext” document, typically written in plain text and interspersed with formatting instructions in a markup language (e.g., XML or Hypertext Markup Language HTML) and/or scripting programming language, and stored on at least one web server in the web domain hosting the web site to which the web page belongs. Web pages are accessed and transported (e.g., between the web server in the web domain and a client computing device) using the Hypertext Transfer Protocol (http). A secure web page is accessed and transported using HTTP-Secure or “https,” which employs encryption in the form of a “secure socket layer” (SSL) to provide security and privacy for the consumer of the web page content (see below). An Internet browser (an application resident on a client computing device) retrieves a web page from a web server (via a URL corresponding to the web page), and interprets and/or executes the retrieved web page to render various information on a display device associated with the client computing device (or other user interface device that provides perceivable output, e.g., sound). In some cases, execution of the web page by the browser governs and monitors a user/viewer's experience and interaction with the information rendered on the client computing device, according to the HTML and scripting instructions present in the web page.

Content (or “web page content”): a collection of perceivable or hidden digital assets resulting from the interpretation and/or execution of a web page by a browser. Examples of perceivable digital assets in web page content include, but are not limited to, text, sounds, images, animations, videos, and widgets (e.g., social media-related assets). Examples of hidden digital assets include, but are not limited to, web tracking assets (to monitor user activity on the rendered web page), web analytic service assets (to analyze performance metrics associated with the web site and rendering of web pages), and privacy-related assets (to provide privacy-related functionality). An executed web page may give rise to multiple digital assets of various types.

Element (or “web page element”—also referred to colloquially as a “Tag”): a coded structure in a web page (or existing as an isolated file that may be incorporated into a web page and/or otherwise executed by a browser) that includes an opening tag to identify the type of element, element contents (not to be confused with web page content), and typically also a closing tag. Given the opening and closing tags that typically define the “start and stop boundaries” of a web page element, such elements themselves as a whole are sometimes referred to simply as “tags.” Web page elements (or so-called “tags”) define various formatting attributes of a web page as well as the digital assets constituting the web page content (some of which digital assets may be perceivable and others of which may be hidden upon interpretation and execution of the web page by a browser). A single web page may contain hundreds or thousands of elements; typically, a web page includes at least four elements, namely, the HTML element, the head element, the title element, and the body element. Other examples of web page elements include, but are not limited to:

Perceivable elements (giving rise to perceivable digital assets of web page content): Text elements; Static image elements (e.g., GIF, JPEG, PNG, SVG, Flash); Animated image elements (e.g., GIF, SVG, Flash, Java applet); Video elements (e.g., WMV, RM, FLV, MPG, MOV); Grouped elements (e.g., navigation bar, other web site standard information elements); Interactive elements (web page viewer may interact with web page content)—Hyperlinks, Buttons, Interactive text elements, Interactive image/video elements (“click to play” images, games);

Hidden elements (some of which may give rise to hidden digital assets of web page content): Comments; Metadata; Style information (e.g., Cascading Style Sheets); Scripts (see below).

Script: a type of web page element or “tag” whose contents comprises a sequence of instructions, written in a particular scripting language other than HTML (e.g., JavaScript, PHP, Perl), that is interpreted and executed on the client computing device (e.g., when the web page is loaded and executed by the browser on the client device, or when a hyperlink in the rendered web page is activated) to automate the execution of certain tasks.

Resource: (or “web resource”) a file stored on a web-accessible server that can be identified and accessed via a URL. Examples of web resources include web pages, media files in various formats (e.g., text documents, images, videos, etc.), and files containing one or more web page elements or “tags” in isolation (including scripts in any of a variety of scripting languages—see above). A digital asset resource is a file that includes data or code to directly instantiate a perceivable or hidden digital asset upon execution by a browser of a web page element that includes or points to the digital asset resource.

Redirection Command: a command contained in the element contents of a web page element and having a URL as a parameter, wherein the URL points to an Internet location in a foreign web domain (i.e., a different domain than the domain of the web page that includes the web page element containing the redirection command). Thus, a web page element may “call” (e.g., go to, request, and/or retrieve) a foreign web resource in a foreign web domain via a redirection command.

Source: the provider of a resource, i.e., the curator/owner of a web domain that includes a web server on which a resource is stored. In connection with the execution of a web page, a publisher is the owner/curator of the host web site to which the web page belongs (and, as such, the source of the web page hypertext document). An ultimate source refers to a provider of a digital asset resource that includes data or code to directly instantiate a perceivable or hidden digital asset upon execution of the web page, whereas an intermediate source refers to a provider of a resource that in turn points (e.g., via a redirection command) to another resource (provided by a different intermediate source or an ultimate source).

Third-party Digital Technology Vendor: a source of a foreign web resource that is called by a web page element redirection command when the web page including the web page element is executed by a browser (i.e., the third-party digital technology vendor is the owner/curator of a foreign web domain in which the foreign resource is stored and from which the foreign resource is requested or “called”). While many elements of a given web page typically are written by or on behalf of the web site curator or web domain owner (i.e., the “publisher”), some elements of a given web page may be provided by third-party digital technology vendors (also referred to as “third-party vendors” or simply “vendors”). Such third-party vendors may have contracts with the web site publisher to provide additional content for one or more web pages, wherein the additional content originates from a foreign web domain (accordingly, such additional content is referred to as foreign content). A given third-party vendor may be an intermediate source or an ultimate source; in particular, a third-party vendor acting as an intermediate source provides a web page element that calls a first foreign resource, and this first foreign resource in turn calls a second foreign resource provided by a different third-party or “piggyback vendor.”

Web site Marketing Cloud: the collection of third-party digital technology vendors (including piggyback vendors) that are associated with a given web site via redirection commands present in web page elements of web pages of the web site (some of which redirection commands may point to foreign resources that also include redirection commands).

Vendor Tag: a web page element or “tag” (which could be a script) provided by a third-party vendor and including at least one redirection command. When a web page including a vendor tag is executed by a browser, the vendor tag calls (by virtue of the redirection command) one or more foreign resources in a foreign web domain that indirectly or directly give rise to perceivable or hidden foreign content (also referred to as “secondary content”) present in the web page content. Such foreign content may include multiple perceivable or hidden foreign digital assets. Examples of different classifications of vendor tags associated with third-party vendors, and the corresponding different types of foreign digital assets instantiated by such vendor tags, include:

Advertising Tag: A tag that, when executed, displays advertising content (e.g., text, images, video, rich media, or other types of objects);

Tracker Tag: A tag that, when executed, instantiates a tracking digital asset that collects data about the user interacting with the rendered/executed web page for the purpose of audience intelligence and/or behavioral analysis. While vendor tags classified in other categories may also serve this purpose, “tracker tags” are deployed only to follow and attribute activity to a user;

Analytics Tag: A tag that, when executed, instantiates an analytics digital asset that collects information designed for website audience intelligence (e.g., location, time spent on the page, and referral and/or exit data);

Privacy Tag: A tag that, when executed, instantiates a privacy digital asset that discloses and/or provides opt-out functionality (e.g., in-ad notices or site certification badges);

Widget Tar: A tag that, when executed, instantiates a web widget digital asset, i.e., user-facing page functionality (e.g., social buttons, comment forms, and video players); and

Unknown Tag: A tag that is identified as a product of a known third-party vendor, but for which the function of the tag (and any corresponding digital asset that may be instantiated on execution of the unknown tag) has not yet been determined.

A first vendor tag that is present as an element of a web page may call and load (when the web page is interpreted or executed by a browser operating on a client computing device) a foreign resource from a foreign web domain, and this foreign resource may include, or itself be, a second vendor tag. This second vendor tag is sometimes referred to as a piggyback vendor tag provided by a piggyback vendor. The piggyback vendor tag may be interpreted or executed by the browser on the client computing device and in turn cause some other foreign resource(s) to be transferred from another foreign web domain (e.g., operated/curated by the piggyback vendor) to the browser operating on the client computing device.

Vendor Chain (also referred to as “Chain of Resources/Events”): multiple third-party vendors (including “piggyback vendors”) linked by one or more redirection commands. A request and retrieval of a foreign resource via a redirection command is referred to as an event. A first foreign resource requested and retrieved in a first event via execution of a web page by a browser may include another request and a URL for a second foreign resource, and result in the browser subsequently requesting and retrieving the second foreign resource (from the same source or a different source) in a second event. Similarly, the second foreign resource may include another request and a URL for a third foreign resource, and so on. Parentage refers to the parent/child relationship between two foreign resources/vendor tags (a parent tag that calls a child tag—note that a child tag can be a parent tag to a subsequent child tag that it calls/retrieves, making the original parent tag in this example a “grandparent”). This chain of resources/events may continue until a foreign digital asset resource is retrieved; as noted above, a digital asset resource itself does not involve another resource request, but instead constitutes a file that includes data or code to instantiate a perceivable or hidden digital asset upon execution of the web page.

Mixed Content Web page: a web page that includes both secure web page elements (that call resources using secure URLs, e.g., via https) and non-secure web page elements (that call resources using non-secure URLs, e.g., via http).

Components of a System for Surveillance of Third-Party Digital Technology

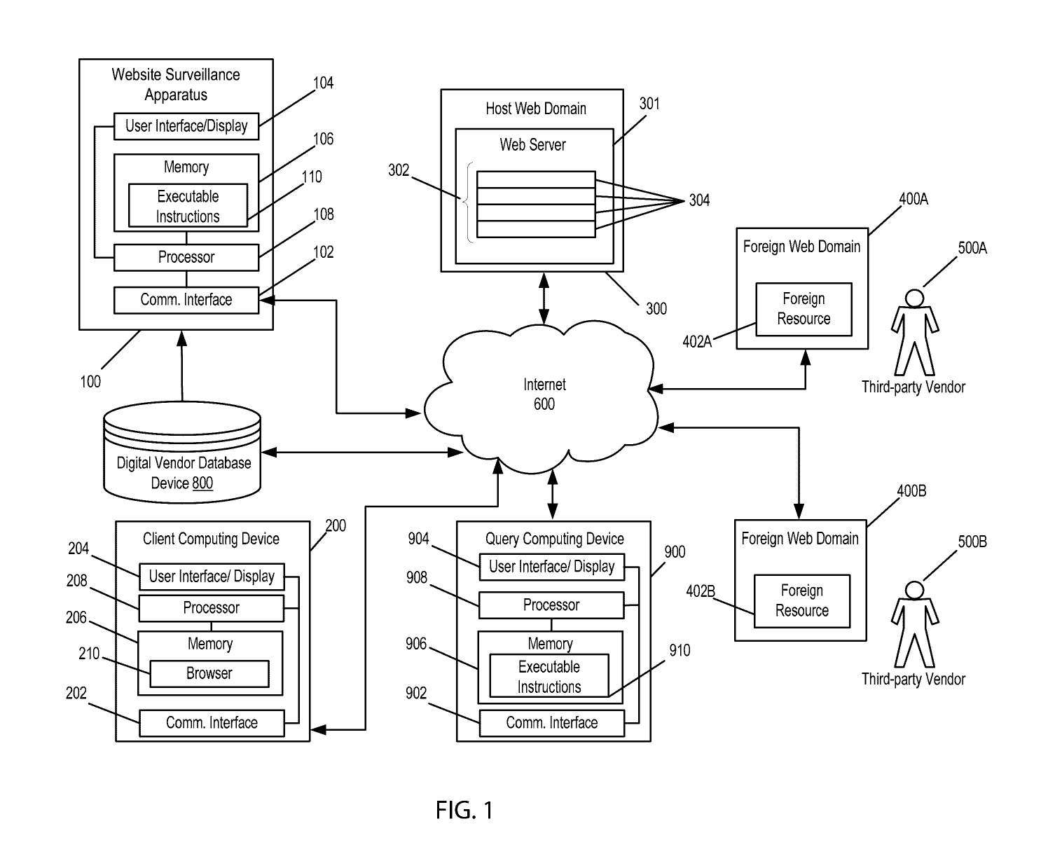

FIG. 1 illustrates a high level view of a system for surveillance of third-party digital technology vendors in a web domain, according to one embodiment of the present invention. A website surveillance apparatus 100 includes a user interface/display 104 and/or graphical user interface (GUI) to display and receive information from a user. The user interface can received commands from a processor 108 physically coupled to a memory 106 with a set of executable instructions 110 which enables a plurality of functions performed by the apparatus 100. Additionally the apparatus 100 includes a communication interface 102 to receive and transmit data to one or more devices through the Internet 600.

The apparatus 100 is communicatively coupled to the Digital Vendor Database Device 800. The database device 800 stores a collection of third party vendor's information including but not limited to vendor names, vendors descriptions, vendor tags and unique patterns characterizing a vendor tag. The apparatus 100 can retrieve the vendor information stored in the database device 800 upon request to perform one or more operations for example to identify the origin of a web resource. Moreover, the database device 800 is enabled to receive and transmit data to one or more devices through the Internet 600.

The client computing device 200 includes a user interface/display 204 or graphical user interface to display and receive information from a user. The user interface can received commands from a processor 208 physically coupled to a memory 206 with a set of executable instructions to run a browser 210 which enables a plurality of functions performed by the device 200 including but not limited to the transmission of foreign web domains data to the apparatus 100. Additionally the device 200 includes a communication interface 202 to receive and transmit data to one or more devices through the Internet 600.

The apparatus 100 can load one or more web resources associated with a website 302 comprising a collection of linked web pages 304 residing in a web server 301 which is part of a host web domain 300. The web resources associate with the website 304 can be foreign resources e.g., 402A and 402B. Originated in a foreign web domain e.g., 400A and 400B. Such foreign web domains can be managed and/or owned by third-party vendors 500A and 500B.

The query computing device 900 includes a user interface/display 904 and/or graphical user interface (GUI) to display and receive information from a user. The user interface 904 can received commands from a processor 908 physically coupled to a memory 906 with a set of executable instructions 910 which enables a plurality of functions performed by the apparatus 900 including transmitting and receiving data from the apparatus 100. Additionally the apparatus 900 includes a communication interface 902 to receive and transmit data to one or more devices through the Internet 600.

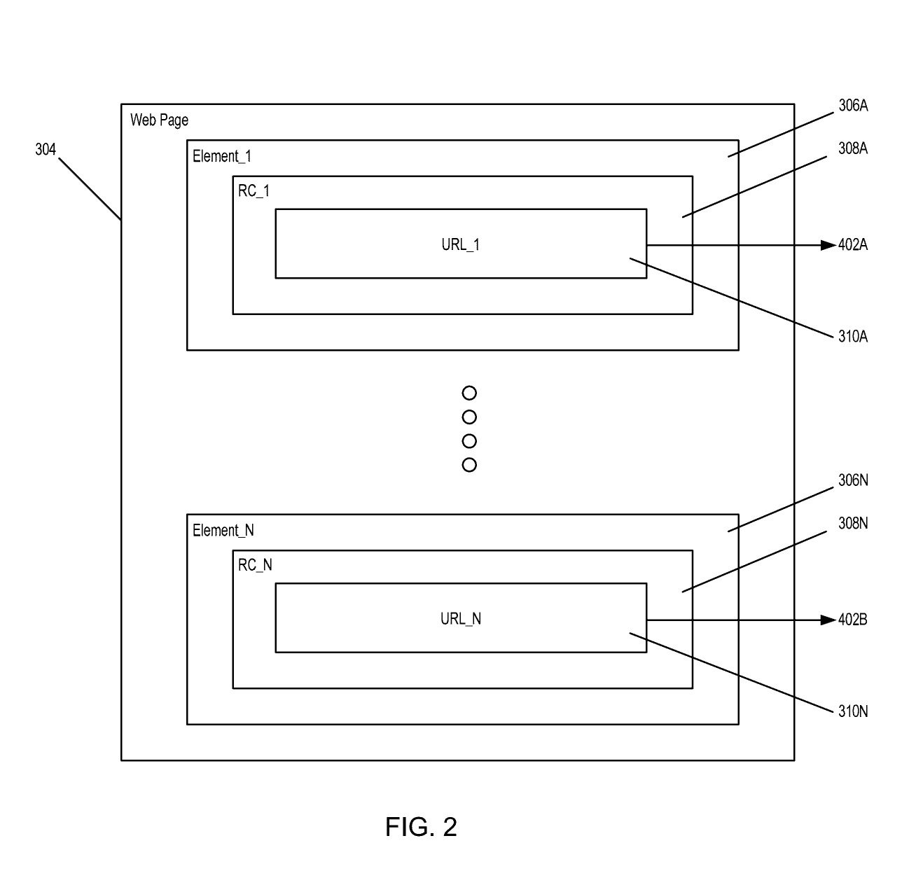

FIG. 2 illustrates an example of data structures in a web page 304 including web elements, redirection commands and uniform resource locaters (URL), according to one embodiment of the present invention. A web page 304 can comprise content including a plurality of web elements for example 306A and 306N. Some web page elements can further comprise one or more redirection commands 308A-308N for example a script to retrieve a digital asset resource from foreign web domain specified by an URL for example 310A-310N can point to foreign web domains 402A and 402B respectively owned by a third-party digital technology vendor. To that extent, the foreign web domains 402A and 402B are the ultimate source of the retrieved digital asset resource.

In some other instances, a first foreign web domain may instead or additionally return a foreign resource with an additional redirection command having an additional URL pointing to an additional foreign web domain associated with and additional third-party digital vendor. In such a case the first foreign web domain and the additional foreign web domain may constitute a vendor chain or part of a vendor chain.

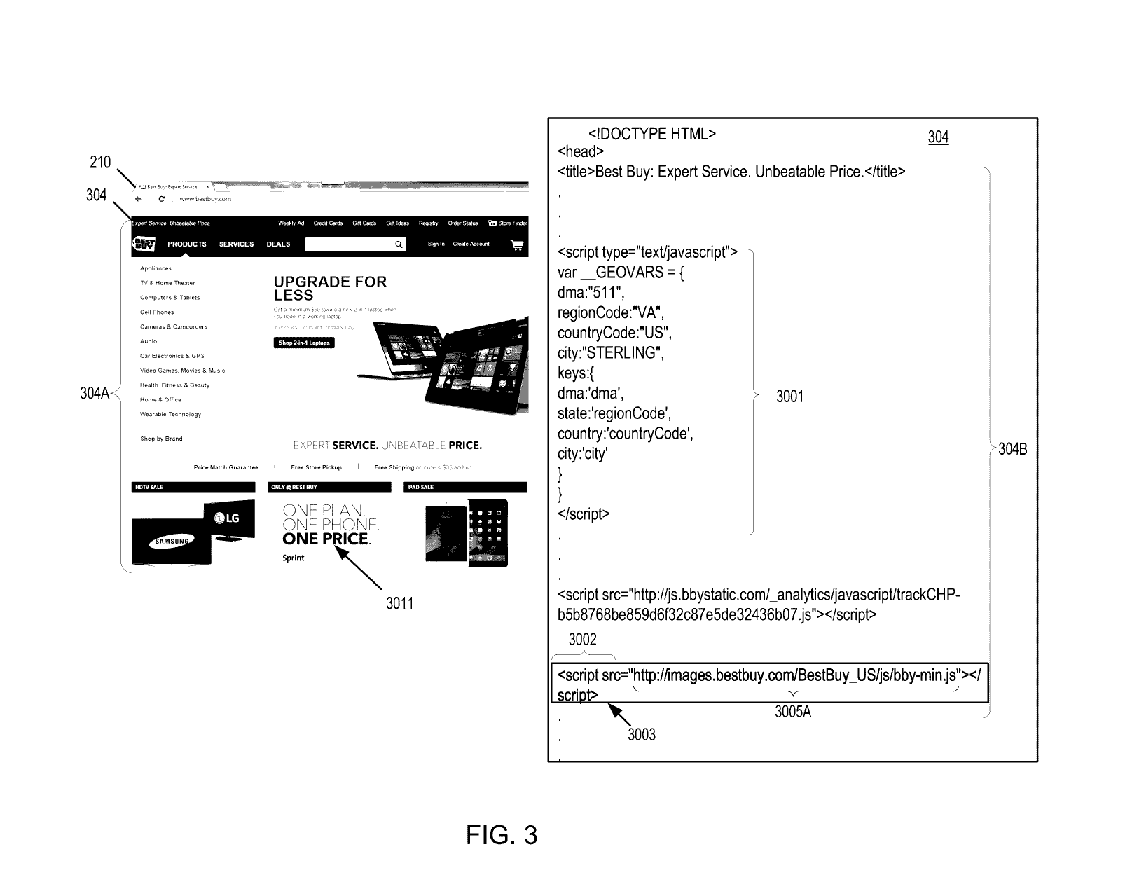

FIG. 3 illustrates the front-end view of a web page and portion of the web page source code, according to one embodiment of the present invention. A user in communication with the client computing device 200 can enter the URL for a website 302 through the browser 210. In such a case, the user interface display 204 can show a web page 304 comprising a collection of visible web elements 304A for example the advertisement 3011. In addition the web page 304 can also include a plurality of non-visible web elements 304B for example the script 3001.

One or more redirection commands can be included within the non-visible web elements 304B. For example, the web element 3003 comprises a redirection command 3002 to the URL 3005.

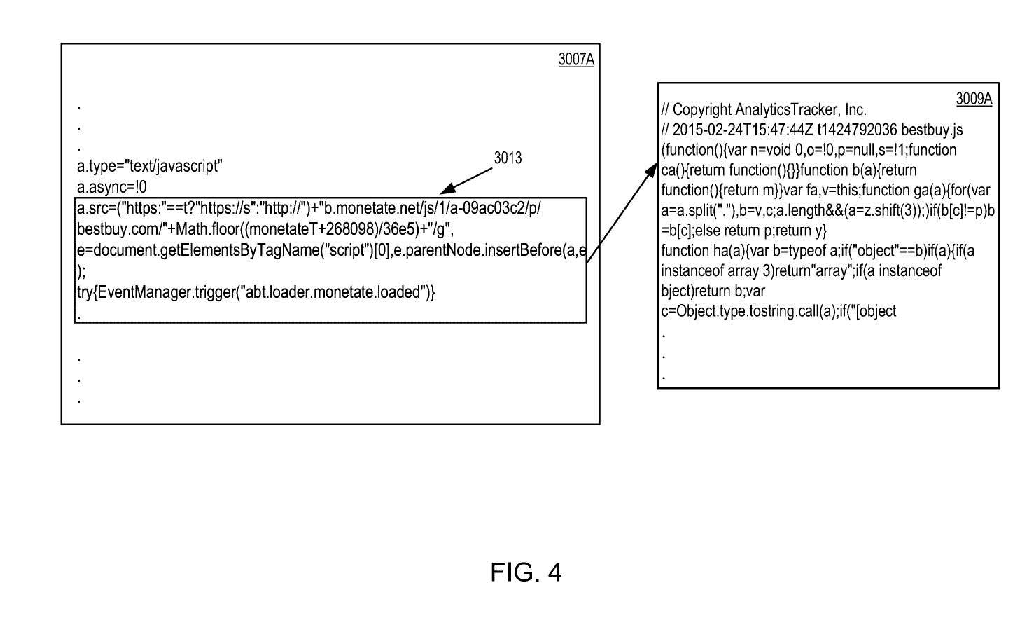

FIG. 4 illustrates an example of a foreign web resource, according to one embodiment of the present invention. A redirection command can be executed and/or interpreted by the browser 210. For example, when the redirection command 3002 in FIG. 3 is executed, it will load the web resource 3007A. The web resource 3007A can also include visible and non-visible web elements. Moreover, the web resource 3007A can include a web element 3013 comprising a redirection command with a URL directed to a foreign web domain.

In some instances, a redirection command to a foreign web domain can retrieve a foreign digital asset. For example, redirection command 3013 can retrieve a foreign digital asset configured to serve as a tracker provider of analytics for website publishers 3009A.

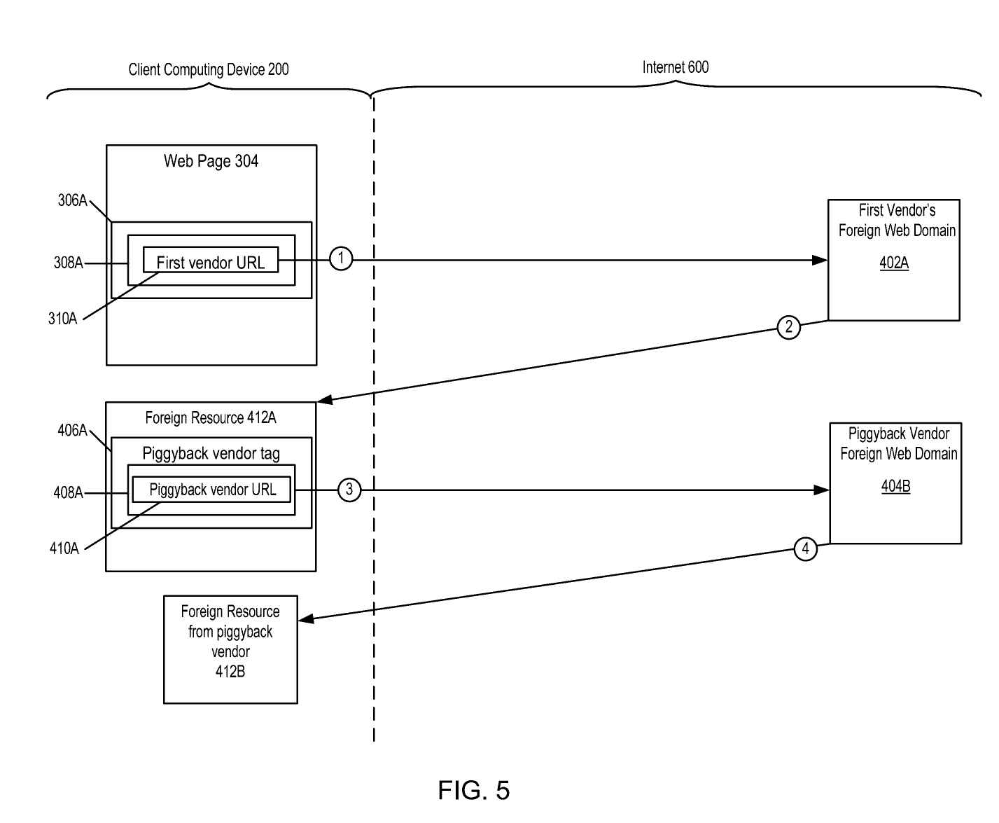

FIG. 5 illustrates an example of a client computing device loading a web resource from a piggyback vendor, in one embodiment of the present invention. In some instances a user in communication the client computing device 200 can load the web page 304 to be display. The web page 304 can have a web element 306A with a redirection command 308A having a URL 310A directed to a first vendor's foreign web domain 402A. The client computing device 200 can retrieve the foreign resource 412A which can also include the web element 406A having a redirection command 408A with a URL 410A directed to a piggyback vendor's foreign web domain 404B. After the execution of the redirection command 408A the client computing device 200 retrieves a foreign resource 412B from the piggyback vendor foreign web domain 404B. The foreign resource 412B can be any of a privacy service element, an advertisement, a widget, a tracker, an analytics tool and the like foreign resources.

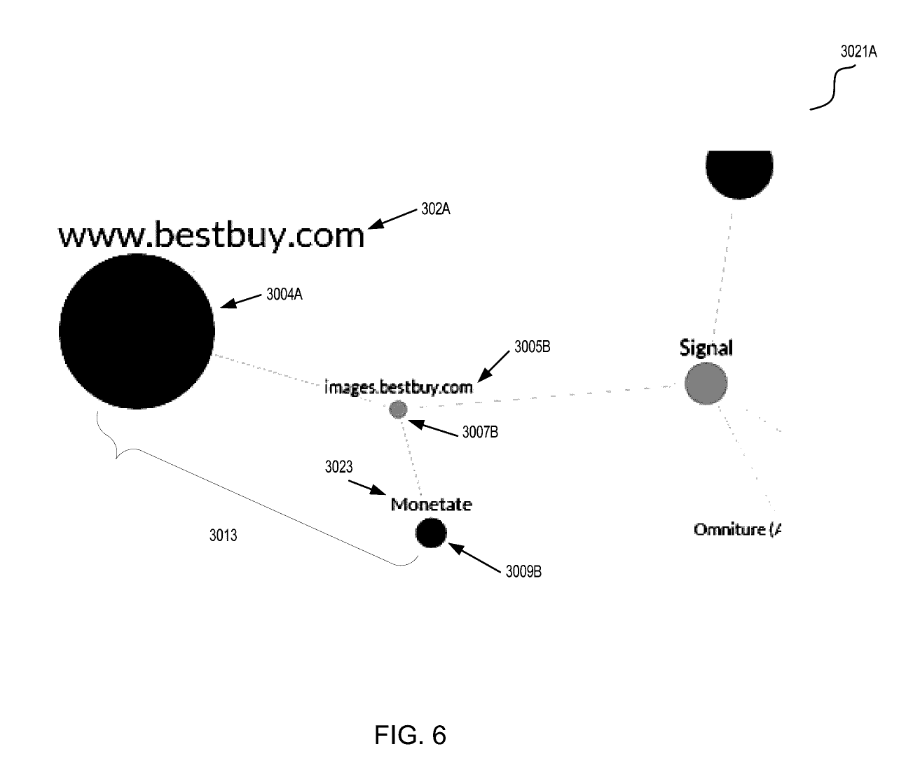

FIG. 6 illustrates an example of a graphical representation of a chain of resources/events, in one embodiment of the present invention. The sequence of redirection commands originated from the web element 3003 in FIG. 3 to the foreign digital asset 3009A in FIG. 4 can be visually represented as a chain of resources/events e.g., 3013. The chain 3013 includes a starting node 3004A representing a website associated with the URL 302A. During the loading of the website associated with the URL 302A, one or more redirection events can be triggered, represented as directed edges in the graph 3021A. A redirection event can load a foreign resource (e.g., 3007A in FIG. 4) from the intermediate source 3005B, such an intermediate resource is represented in the graph 3021A as the intermediate node 3007B. Moreover, during the loading of the resource 3007A, an additional redirection event can occur. For example, when the resource 3007A loads a digital asset resource (e.g., 3009A in FIG. 4) from the ultimate source 3023, such a digital asset can be represented as a leaf node 3009B and classified according to one or more categories including but not limited to publisher elements, privacy service, advertisement, widget, tracker, and analytics tool.

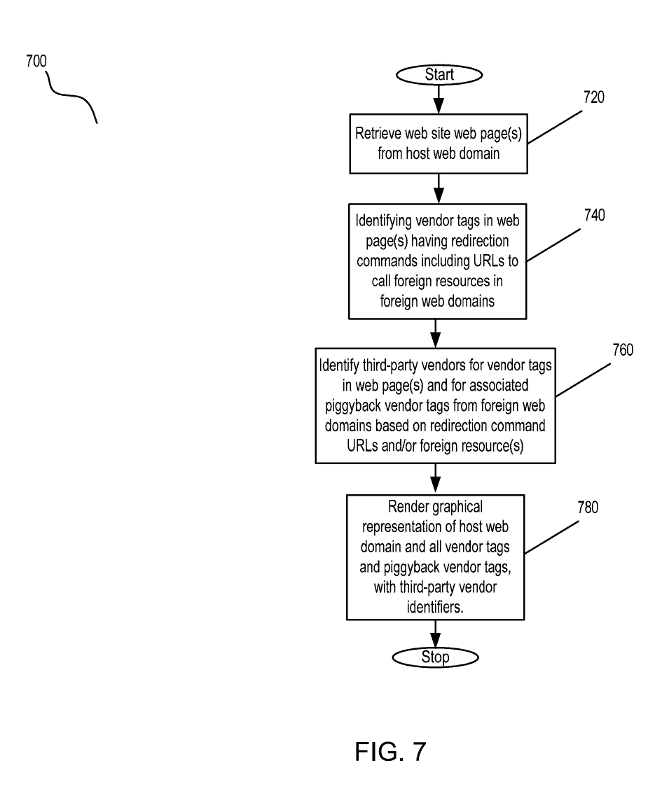

FIG. 7 illustrates a first flowchart representing part of the instructions executed by a web site surveillance apparatus, according to one embodiment of the present invention. The executable instruction stored in the memory of the web site surveillance apparatus 100 (FIG. 1) can include processor readable instructions to retrieve web site web page(s) from a host web domain 720. The apparatus 100 can thereafter identify vendor tags in webpage(s) having redirection commands including URLs to call foreign resources in foreign web domains e.g., step 740. Then, the apparatus 100 can identify third-party vendors for the vendor tags in webpage9s0 and for associated piggyback vendor tags from foreign web domains based on redirection commands, URLs in the redirection commands and retrieved foreign resources e.g., step 760. The apparatus 100 can additionally render a graphical representation of the host web domain, and all vendor tags and piggyback vendor tags, with third-party vendor identifiers e.g., step 780.

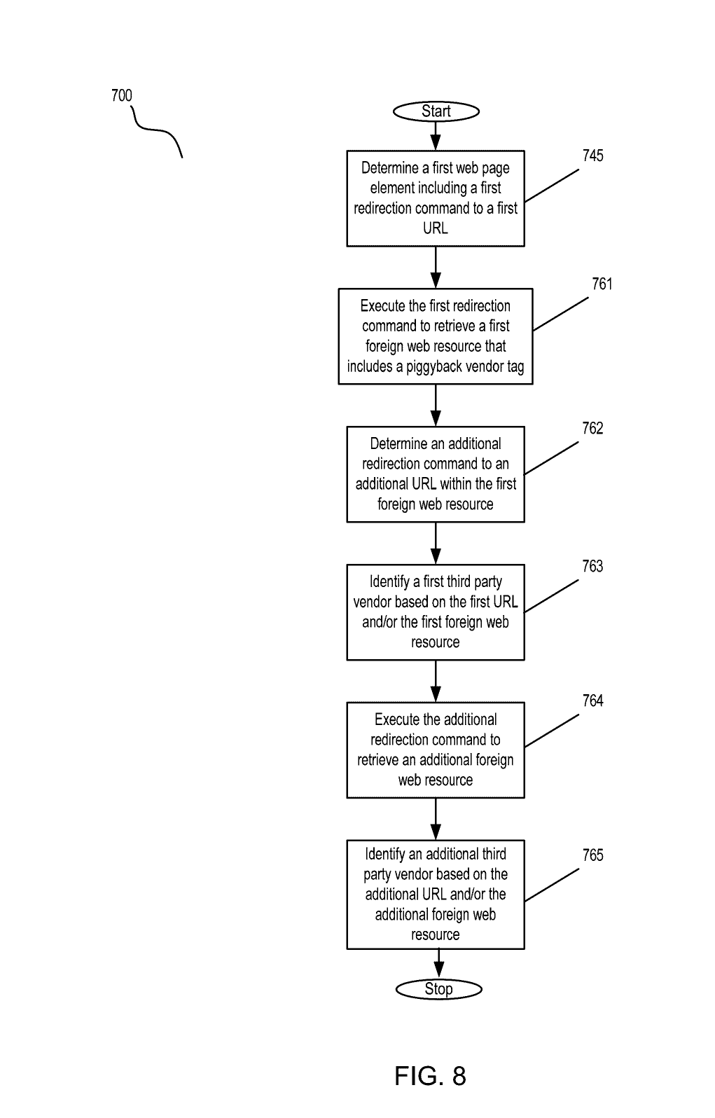

FIG. 8 illustrates a second flowchart representing part of the instructions executed by a web site surveillance apparatus, according to one embodiment of the present invention. In some additional instances the apparatus 100 (FIG. 1) can determine a first web page element including a first redirection command to a first URL 745. Thereafter, the apparatus 100 can execute the first redirection command to retrieve a first foreign web resource that includes a piggyback vendor tag 761 and determine an additional redirection command to an additional URL within the first foreign web resource 762. A first third-party vendor can be identified by the apparatus 100 based on the first URL and/or the first foreign web resource 763. Then, the apparatus 100 can execute the additional redirection command to retrieve an additional foreign web resource 764 and similarly, identify an additional third-party vendor based on the additional URL and/or the additional foreign web resource 765. Some variants of the described steps can be executed multiple times until an ultimate source is identified. An ultimate source refers to a provider of a digital asset resource that includes data or code to directly instantiate a perceivable or hidden digital asset upon execution of the web page.

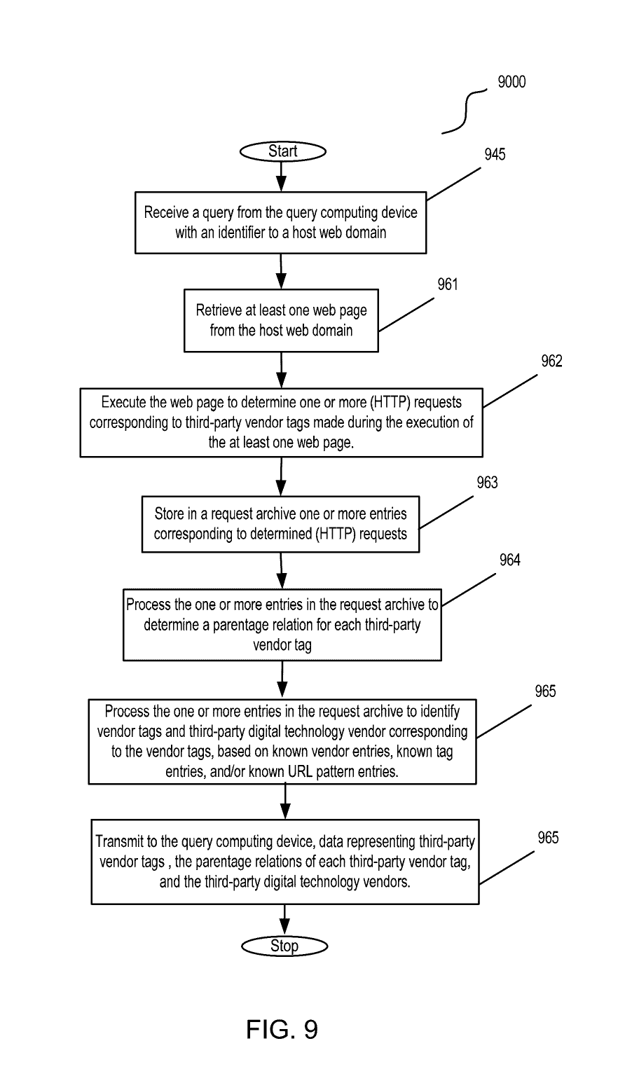

FIG. 9 illustrates a third flowchart representing part of the instructions executed by a website surveillance apparatus, according to one embodiment of the present invention. In some instances, the website surveillance apparatus 100 can receive a query 945 from the query computing device 900. The query 945 can include an URL and/or domain name corresponding to a website hosted by the apparatus 300. For example, the apparatus 300 can be associated to the domain name “www.webServer300.com”. Thereafter, the apparatus 100, can retrieve 961 one or more web pages from the web server 300. The one or more web pages can be loaded and/or executed 962 to determine if there are any HTTP requests corresponding to third-party vendor tags that may be executed upon or after the loading of the one or more webpages. The apparatus 100 does not need to render the content of the one or more webpages. In some implementations, the content of the one or more webpages does not need to be displayed on the apparatus 100. Additionally or alternatively, the electronic content received from the server 300 can be loaded in a safe environment like a sandbox and/or other similar testing environments.

In some implementations the execution of step 962 includes the monitoring or listening of the Transmission Control Protocol (TCP) socket messages. As such, the apparatus 100 can determine if there are any HTTP requests or external calls to foreign or other domains. In some implementations, each or a selected category of socket messages can be captured by the apparatus 100. The captured socket messages can include, for example, any HTTP request or other types of external calls. The HTTP requests can be further analyzed to determine, the time when the request was executed, the time when the response was received, and the type of resource included in the response, for example, media file, trackers, advertisements and the like web resources. Furthermore, the apparatus 100 can also capture the time when a web resource or parent resource originates another HTTP request, external call and other similar events. As such a child web resource can also be identified. Therefore, nested and/or piggyback requests can be similarly analyzed.

Some examples of the messages or notifications that can be utilized to monitor the socket messages include but are not limited to: Network_Requests, Network_Response, Network_DataReceived, Network_LoadingFinished, Network_LoadingFailed, ExecutionContextCreated, ExecutionContextDestroyed and the like methods that can be overridden or enhanced whenever a browser or other similar web navigation application is used. In other implementations, whenever these methods are not configured in a browser or similar application, similar events can be captured by customized event listener modules.

An example of code that can be executed upon the reception of a Network_Response substantially in the form of C Sharp language is provided below:

1. JToken responseToken=token.SelectToken(“response”);

2. item.Connectionld=GetTokenValue<int>(responseToken, “connectionId”, 0);

3. item.Status=GetTokenValue<string>(responseToken, “status”, “ ”);

The code presented above shows the instantiation of a responseToken object which is initialized with the content received from the Network_Response (code line 1). An identifier to the physical connection that was utilized on the request can be extracted from the responseToken (code line 2). Thereafter, the status of the response can be similarly extracted from responseToken (code line 3). Some examples of the statuses include but are not limited to successful transmission, transmission error, server error and the like. A person of the ordinary skill in the art will readily recognize that numerous data related to external requests and other type of events can be similarly obtained by capturing the aforementioned type of messages and notifications.

In some implementations, the data captured from messages and notifications the can be stored 963 in an archive electronic file. For example, one or more entries associated with one or more HTTP requests can be stored in an archive. Thereafter, the apparatus 100 can further process the archive entries 964 to determine a parentage or parent-child relation for each of the HTTP requests corresponding to third-party vendor tags and/or other tags. Such a parentage relation can indicate, for example, whenever after the execution of a vendor tag (the parent) its response initiated a second HTTP request for a tracker (the child).

The process in 964 can include: 1) the identification of tags by comparing the tags to a list or table of candidate tags; 2) the identification of redirect parentage, for example, a response to an HTTP request redirecting to another domain; 3) the identification of direct parentage based on protocol and/or standardized initiators (i.e., HTTP responses indicating in their content that they will be loading other web resources); 4) the analysis or the parentage relation of web resources; 5) the analysis of asynchronous web resources updates (e.g., AJAX technology and the like); 6) the implementation of heuristics to determine the closest parents of a web resource; 7) probabilistic methods to determine parentage relations of a web resource and the like techniques.

The aforementioned techniques can be implemented individually or in ensemble prioritizing according on how accurately each of these techniques provides a parentage or parent-child relationship among the HTTP requests. The apparatus 100 executes a further process 965 to identify vendor tags, based on known vendor entries, known tag entries, and/or known URL pattern entries. Thereafter, the apparatus 100 can transmit to the query computing device 900 distilled data representing third-party vendor tags, the parentage relations of each third-party vendor tag, and identifiers for the third-party digital technology vendors.

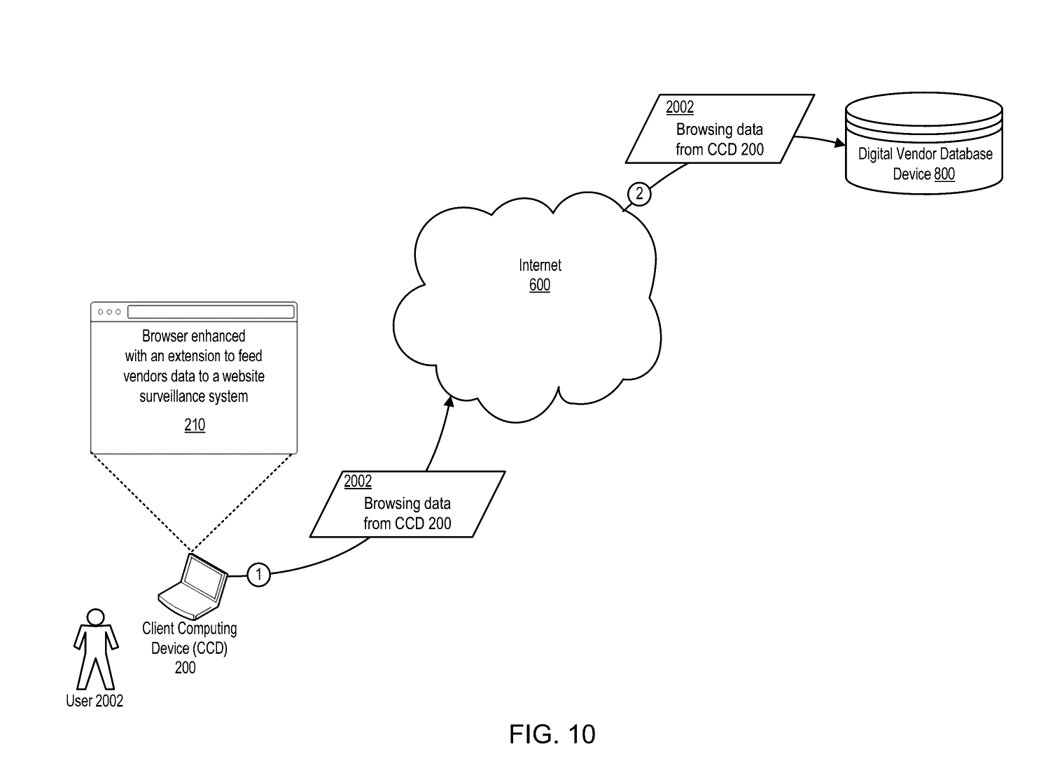

FIG. 10 depicts aspects of a process to feed vendors data to a website surveillance system, according to one embodiment of the present invention. In some instances, a user 2002 in direct communication with the client computing device (CCD) 200 can voluntarily install a browser extension enabling the browser 210 to send browsing data 200 to a digital vendor database device 800. The digital vendor database device 800 can similarly collect data from a plurality of users having voluntarily installed a browser extension to provide browsing data to the digital vendor database device 800. The data stored in the digital vendor database device 800 can be utilized to implement a web resources classification engine configured in the executable instruction from the apparatus 100 (FIG. 1).

Some examples of the browsing data collected from the client computing device 200 include, an identified tracker, the web page where the tracker was found, the protocol of the web page where the tracker was found, the blocking state of the tracker, the domains identified as serving trackers, the time it takes for the page and the tracker to load, the tracker's position on the page, the browser in which the browser extension has been installed, browser extension version information, standard web server log information, such as IP address (which may not be stored) and HTTP headers.

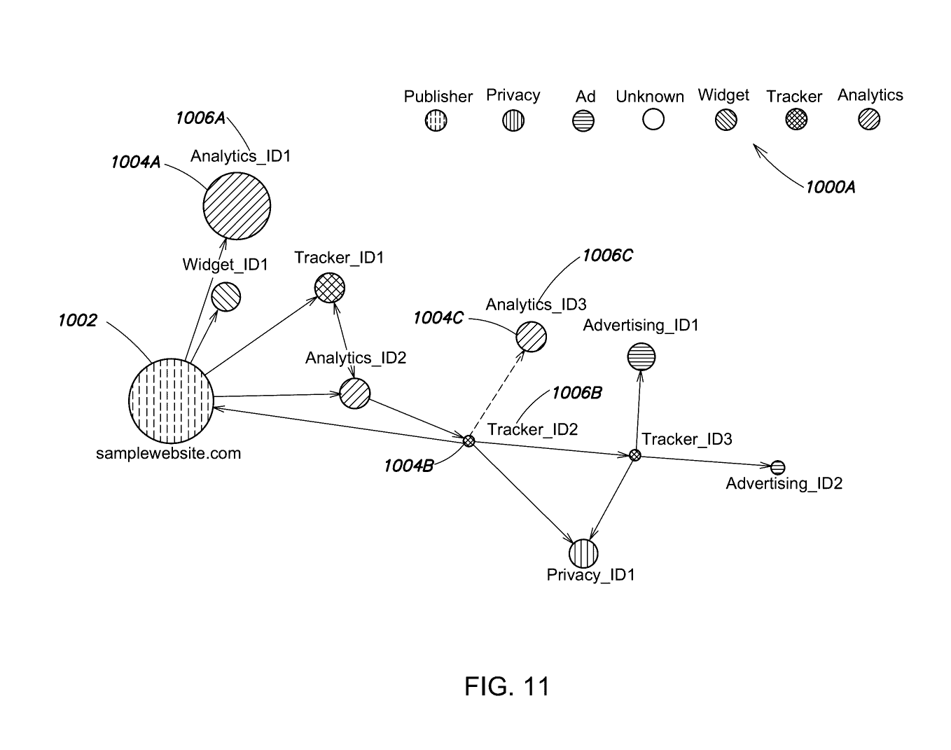

FIG. 11 illustrates an example of foreign resources and parentage relationships that can be embedded in a web page or web domain. In some implementations, a graphical representation 1000 of the host web domain 1002 can be displayed on the user interface 904 of the query computing device 900.

The graphical representation 1000 shows a tracker map with vendor tags identified in the at least one web page, and several of piggyback vendor tags associated with the vendor tags. The host web domain identifier 1002 represents the host web domain associated with a web page. The vendor tag identifiers 1004A, 1004B and 1004C represent different types of web resources associated with vendor tags identified in the at least one web page. For example a tracker web resource can be represented as a sphere or circle 1004B and a textual identifier 1006B. Similarly, the analytics web resource can be represented by the sphere or circle 1004C and the textual identifier 1006C. In this case the tracker represented by 1004B and 1006B can send a HTTP post request with user behavioral information to the analytics web resource represented by 1004C and 1006C. Other web resources can be embedded directly embedded in the content of the web page itself, like the analytics web resource represented by 1004A and 1006A which is represented as a direct child of the root node 1002.

Thus, numerous third-party vendor identifiers, can be graphically associated with the numerous vendor tag identifiers, representing numerous third-party vendors respectively associated with different vendor tags identified in at least a web page and/or domain and numerous of piggyback vendor tags (e.g., 1004B and 1004C).

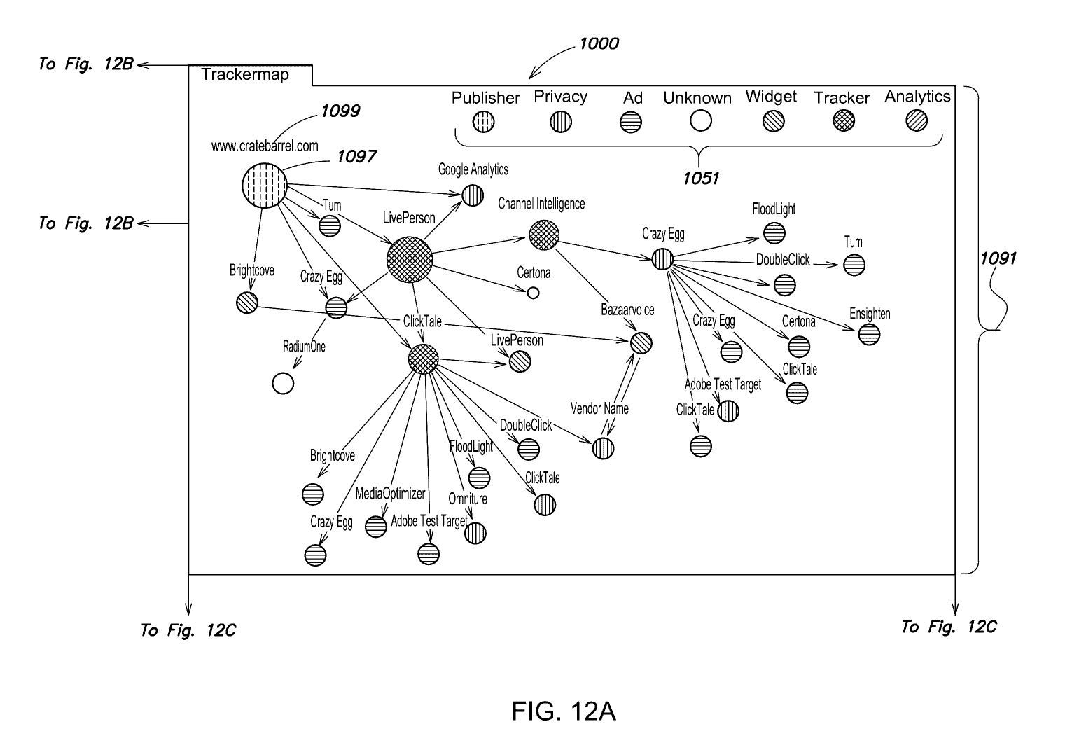

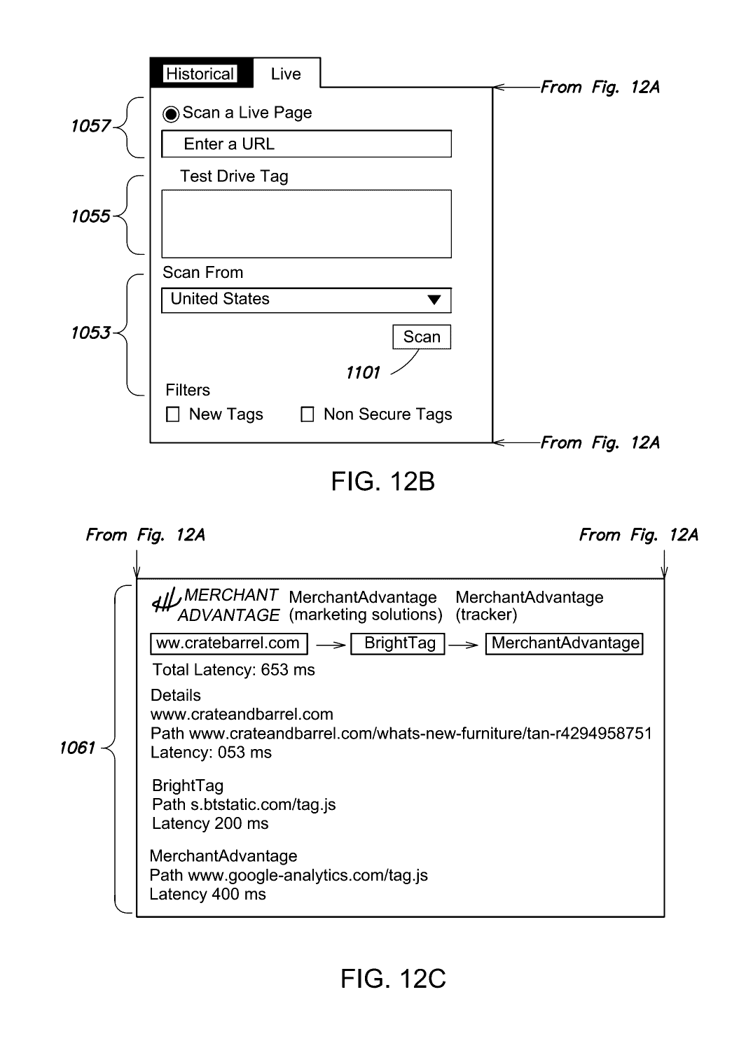

FIG. 12 illustrates a graphical user interface to discover third party vendors and vendor chains and/or chain of resource/events associated with a web domain or web site, according to one embodiment of the present invention. The directed graph 1091 is a representation of a website marketing cloud of the web site 1099. The node 1097 is the graphical representation of the website 1099. The remaining nodes represent foreign web resources that are loaded when the website is loaded on a browser. Each node can be color coded to classify the foreign web resources as category from the set 1051 including publisher resource, privacy service resource, advertisement resource, widget resource, tracker resource, analysis resource, unknown resource and the like.

A user can request to scan a website to display its marketing cloud by entering a URL in the text box 1057. Additionally the user can simulate what would be the effects of adding a vendor tag to the website 1099 utilizing the test drive tag text box area 1055. Moreover, a user can scan the website from the perspective of a client computing device located in the United States and/or other country or geolocation. This feature is relevant because the web resources loaded by a website may vary from country to country and/or from geolocation to geolocation. A user can initiate the scanning process by pressing the button 1101 which will display a cloud marketing cloud graph for example 1091 corresponding to the URL address entered in the text box 1057.

Below the representation of the marketing cloud 1091 a detailed description of each node in a path can be displayed. For example if a user clicks a node on the marketing cloud representation 1091 specific information can be shown regarding the nodes in the path and the latency to load each node, all included in the section 1061.

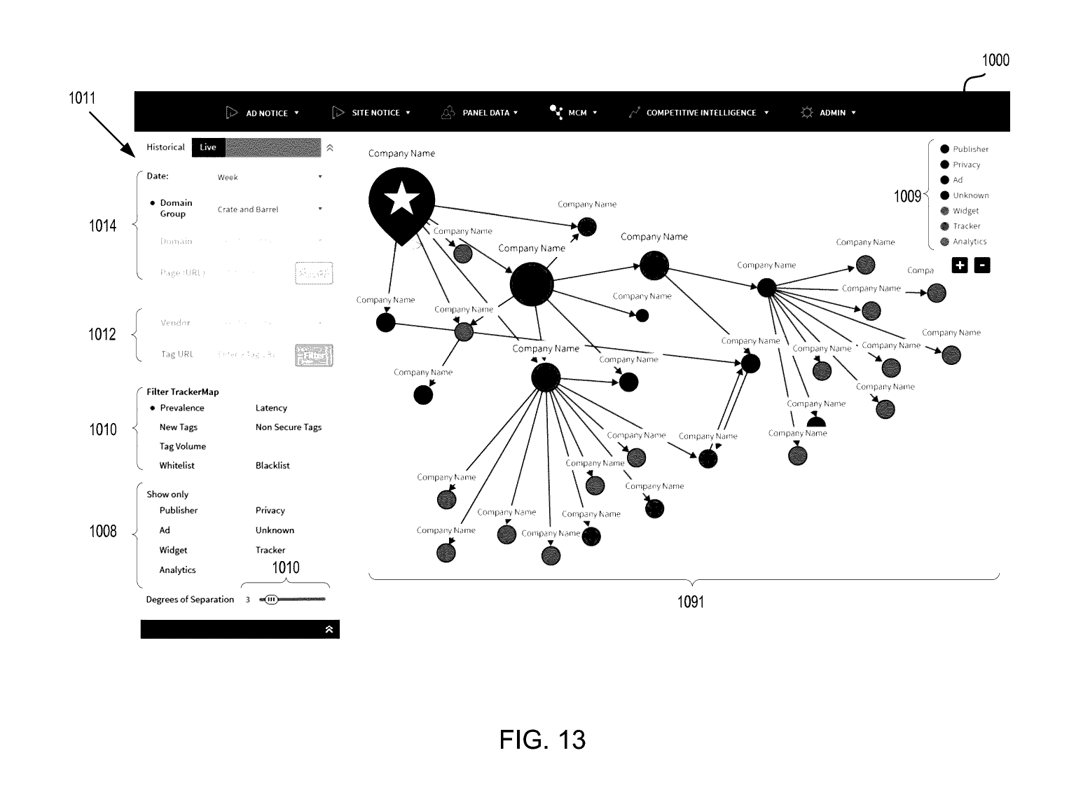

FIG. 13 illustrates a tool bar to filter and view different aspects of a plurality of third party vendor chains associated with a web domain or web site according to one embodiment of the present invention. The user interface can include a tool bar to enable a user to view a marketing cloud from different perspectives. For example, the items in the section 1014 enable a user to select a website by specifying a domain name, a URL or a domain group. Additionally, a user can view the state of a website marketing cloud as it looked in a past period of time, for example, a week ago.

The section 1012 of the tool bar 1011 enables a filtered view of the marketing cloud by vendor name or by a specific URL contained on a vendor tag. The items under the filter trackermap section 1010. Allow a user to switch between prevalence view which shows the identities of the sources of each of the displayed nodes/web resources and the latency view which shows the loading time or latency of each of the nodes/web resources in the marketing cloud. Additionally the filter section can enable a user to view new tags, whitelist tags, blacklist tags, non-secure tags and tag volume. For example a tag volume view can show how many tags or web resources are being called through a node. The remaining filters will be explained in the following figures.

A user have the option to view only one or more types of web resources, for example a user can check one or more checkbox of the items listed under show only section 1008. Such items include publisher elements, privacy services, advertisements, widgets, trackers, and analytic tools. Moreover, users can control the graph depth to specify how many levels below the node representing the website they would like to view. For example, if the user configures the tool 1010 to view 3 degrees of separation the displayed marketing cloud 1091 will show only three nodes below the node representing the scanned website.

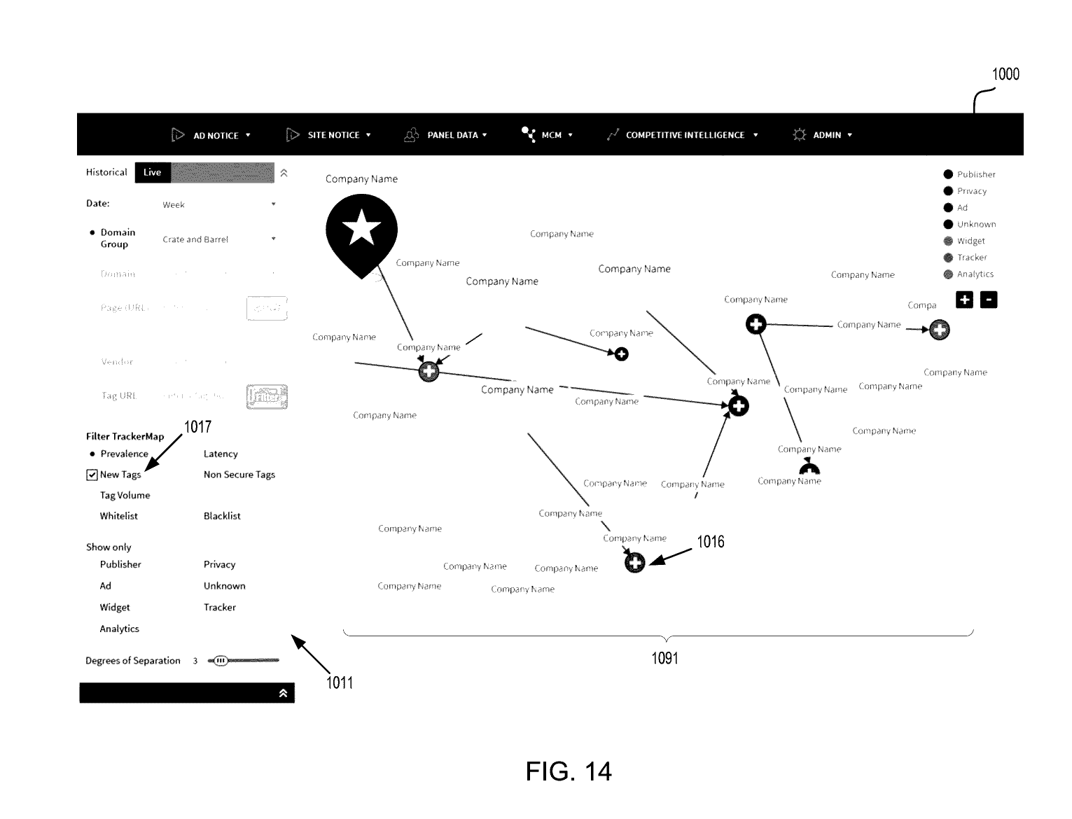

FIG. 14 illustrate a graphical user interface featuring new tags associated with a web domain or website, according to one embodiment of the present invention. In some instances, a user can check the new tags checkbox 1017 under the filter trackermap section on the tool bar 1011. In such a case, any new tag recently added to the website marketing cloud 1091 can be display as nodes with a positive sign in the center for example node 1016.

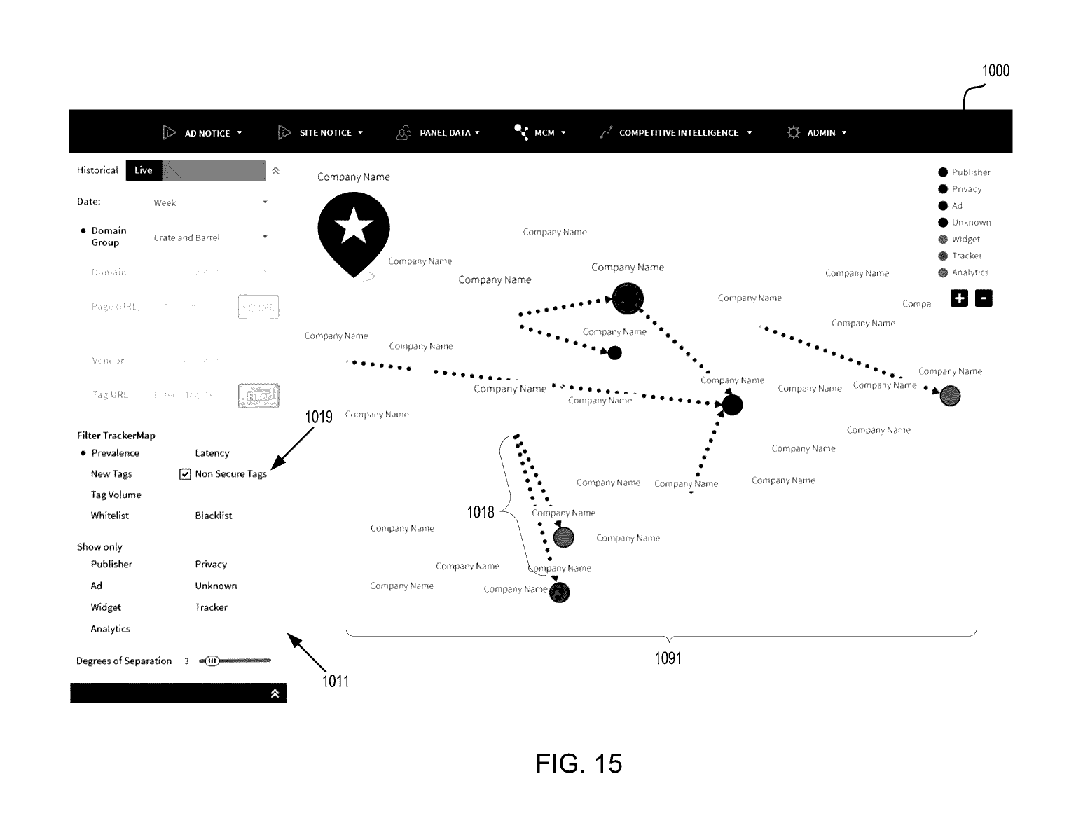

FIG. 15 illustrates a graphical user interface featuring unsecure communications among foreign tags associated with a web domain or website, according to one embodiment of the present invention. In some instances, a user can check the non-secure tags checkbox 1019 under the filter trackermap section on the tool bar 1011. In such a case, any non-secure communication within the marketing cloud 1091 can be display as dotted edges between the nodes wherein the non-secure communication is determined for example edge 1018.

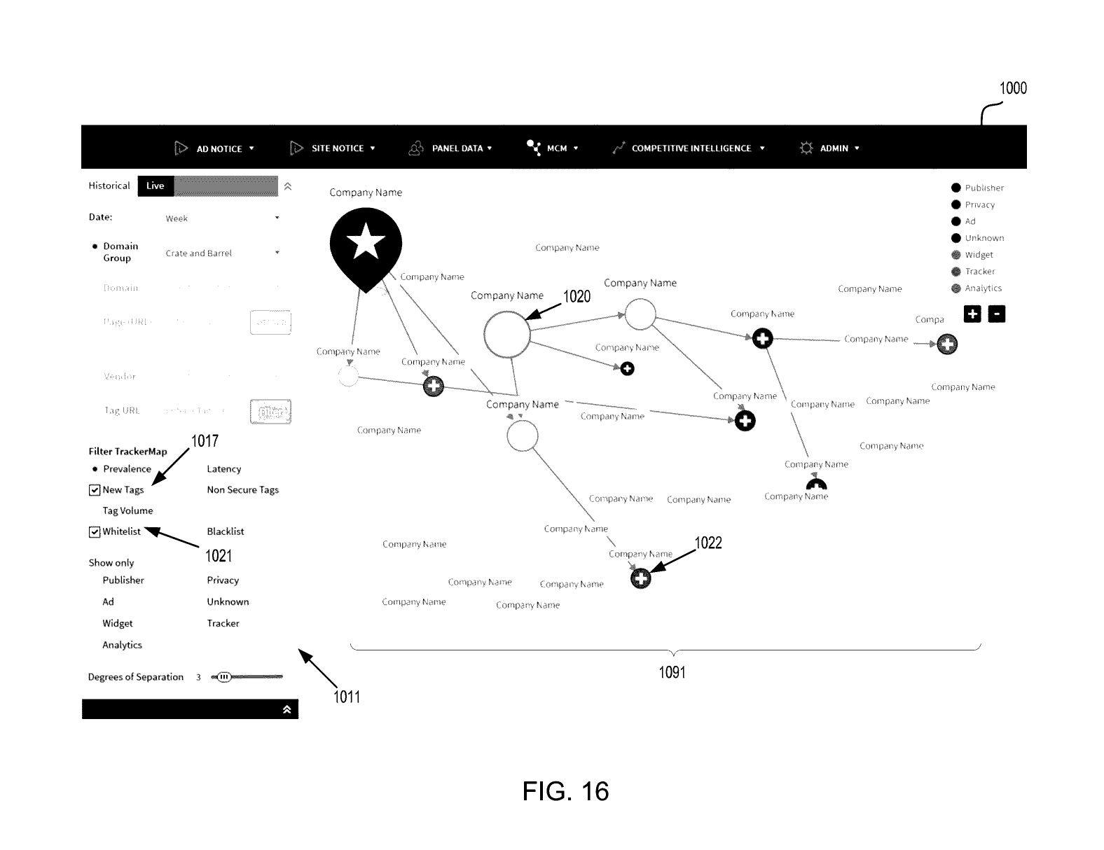

FIG. 16 illustrates a graphical user interface featuring whitelist tags and new tags associated with a web domain or website, according to one embodiment of the present invention. In some instances, a user can check more than one checkbox. For example, a user can check the new tags checkbox 1017 and the whitelist tag checkbox 1021 under the filter trackermap section on the tool bar 1011. A whitelist tag is a tag that a publisher requires to have in his/hers marketing cloud. In such a case, any new tag recently added to the website marketing cloud 1091 can be display as nodes with a positive sign in the center for example node 1022 and additionally any whitelist tag or resource can be display as white nodes for example node 1020.

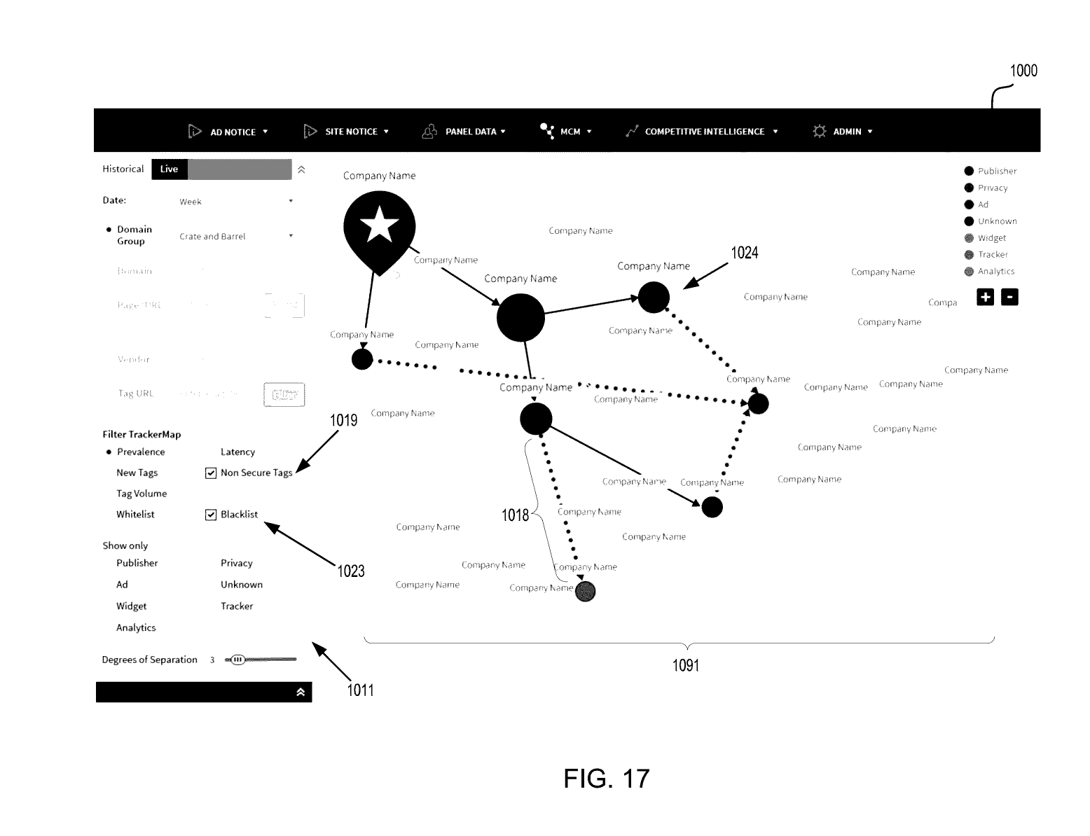

FIG. 17 illustrates a graphical user interface featuring blacklist tags and unsecure communications among third party vendors associated with a web domain or website, according to one embodiment of the present invention. In some instances, a user can check more than one checkbox. For example, a user can check the non-secure tags checkbox 1019 and the blacklist tag checkbox 1023 under the filter trackermap section on the tool bar 1011. A blacklist tag is a tag that a publisher has specify as non-desirable tag to have in his/hers marketing cloud. In such a case, any non-secure communication within the marketing cloud 1091 can be display as dotted edges between the nodes wherein the non-secure communication is determined, for example, edge 1018 and additionally any blacklist tag or resource can be display as black nodes for example node 1024.

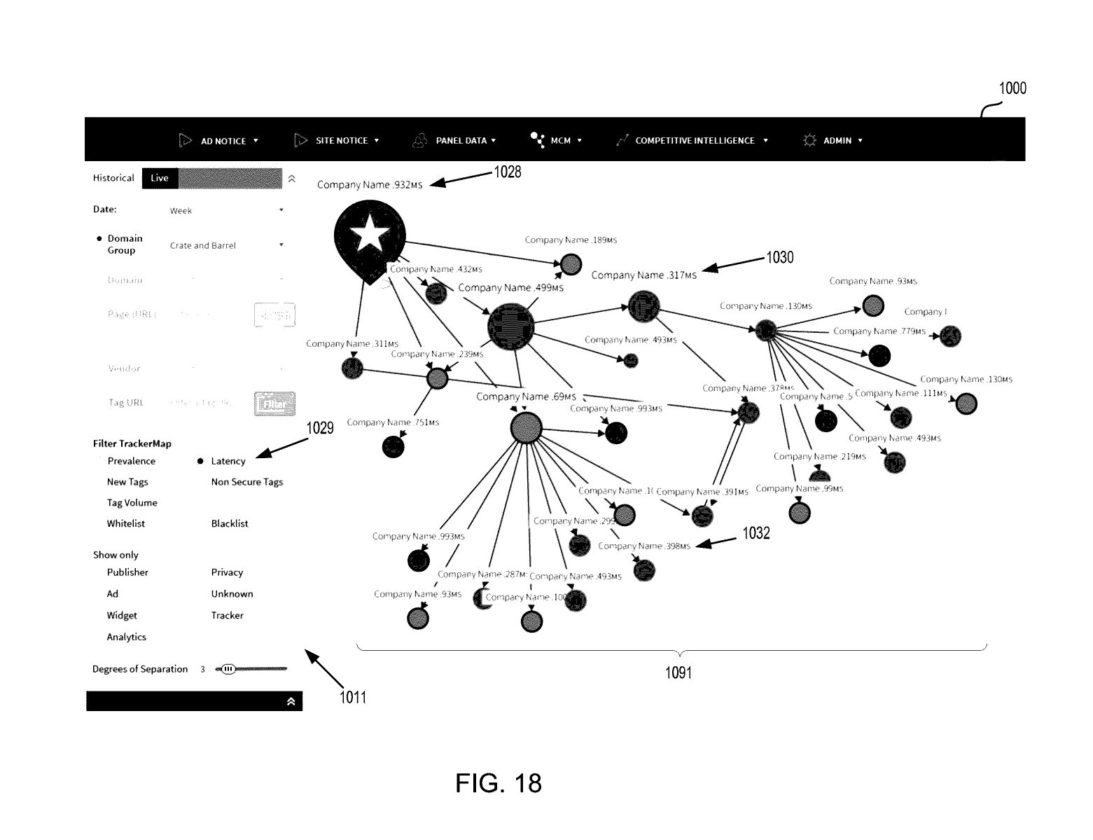

FIG. 18 illustrates a graphical user interface featuring loading latency of vendor tags associated with a web domain or website, according to one embodiment of the present invention. In some instances a user can select the latency radio button 1029 under the filter tracker map section of the tool bar 1011. In such a case, any every node within the marketing cloud 1091 can be display with a time corresponding to load the resource in a client device for example times shown in 1028 and 1030.

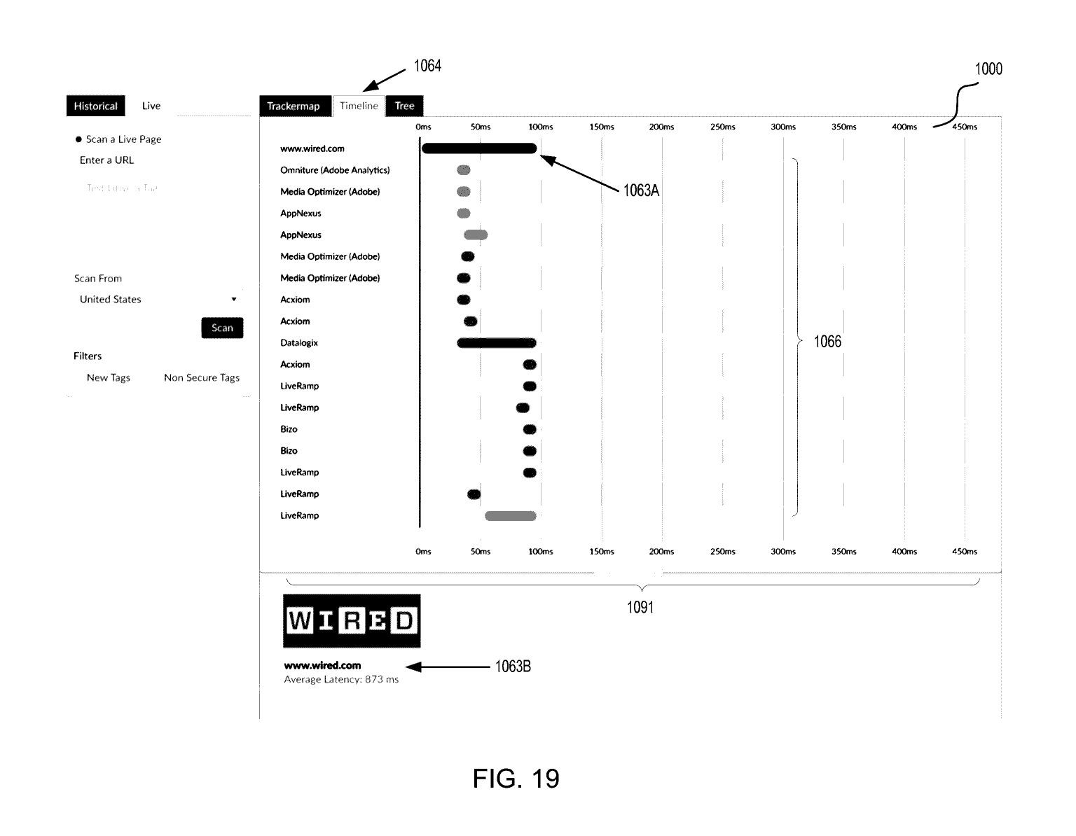

FIG. 19 illustrates a graphical user interface displaying time lines associated with the loading time of a plurality of tags associated with a web domain or website, according to one embodiment of the present invention. In some instances a user can select a timeline view tab 1064. In such a case, a plurality of loading time lines can be display corresponding to the web resources in the marketing cloud 1091. For example, the time line 1063A shows the total loading time to load a website page and the resources 1066. In this view a user can see the loading time of each web resource in 1066. Additionally, a descriptive statistic with respect to the website loading time can be calculated and displayed, for example, an average latency time 1063B.

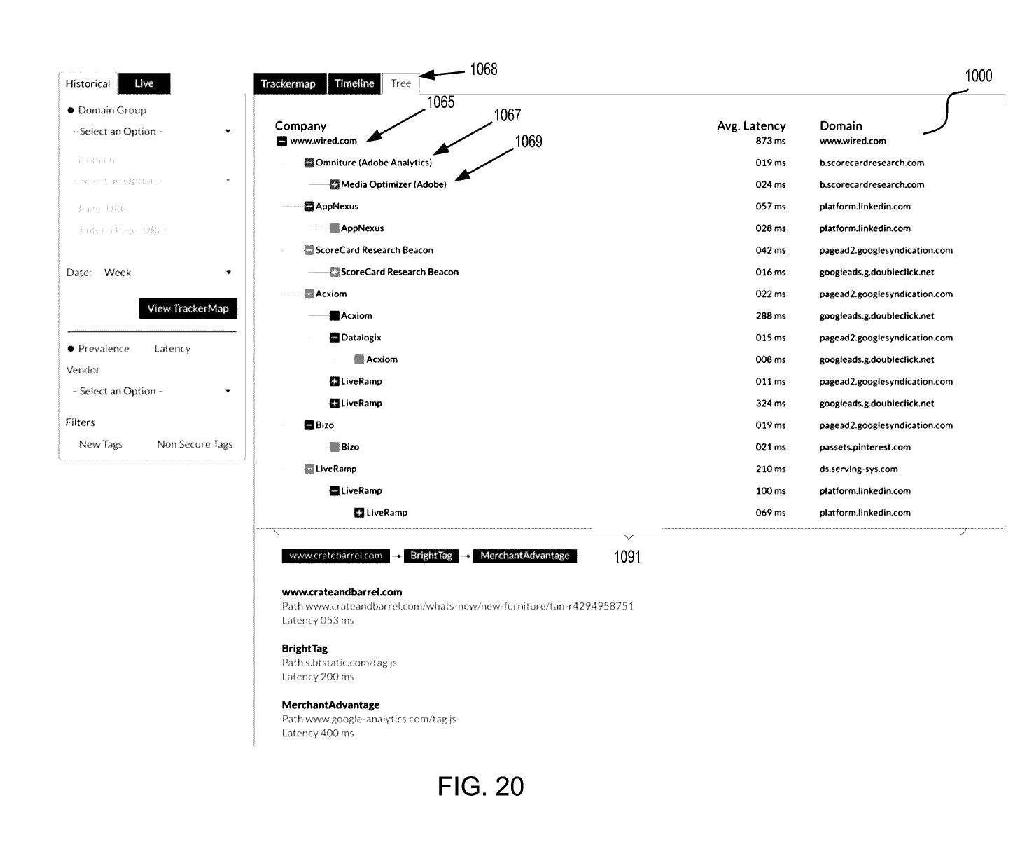

FIG. 20 illustrates a graphical user interface displaying a tree view of a plurality of tags associated with a web domain or website, according to one embodiment of the present invention. In some instances a user can select a tree view tab 1068. In such a case, a plurality tree view of the marketing cloud 1091 can be displayed. Wherein the root node 1065 represents the scanned website and each intermediate node e.g., 1067 and leaf node e.g., 1069 represent web resources loaded with the website 1065.

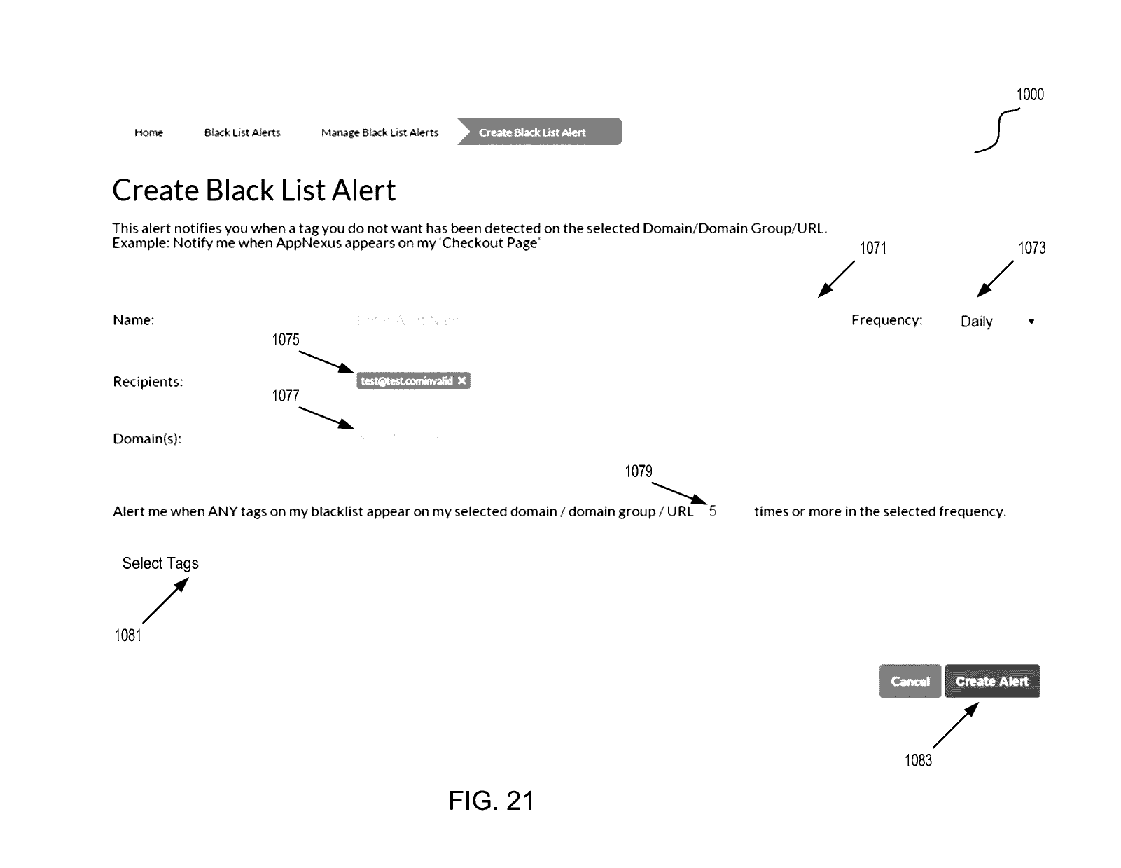

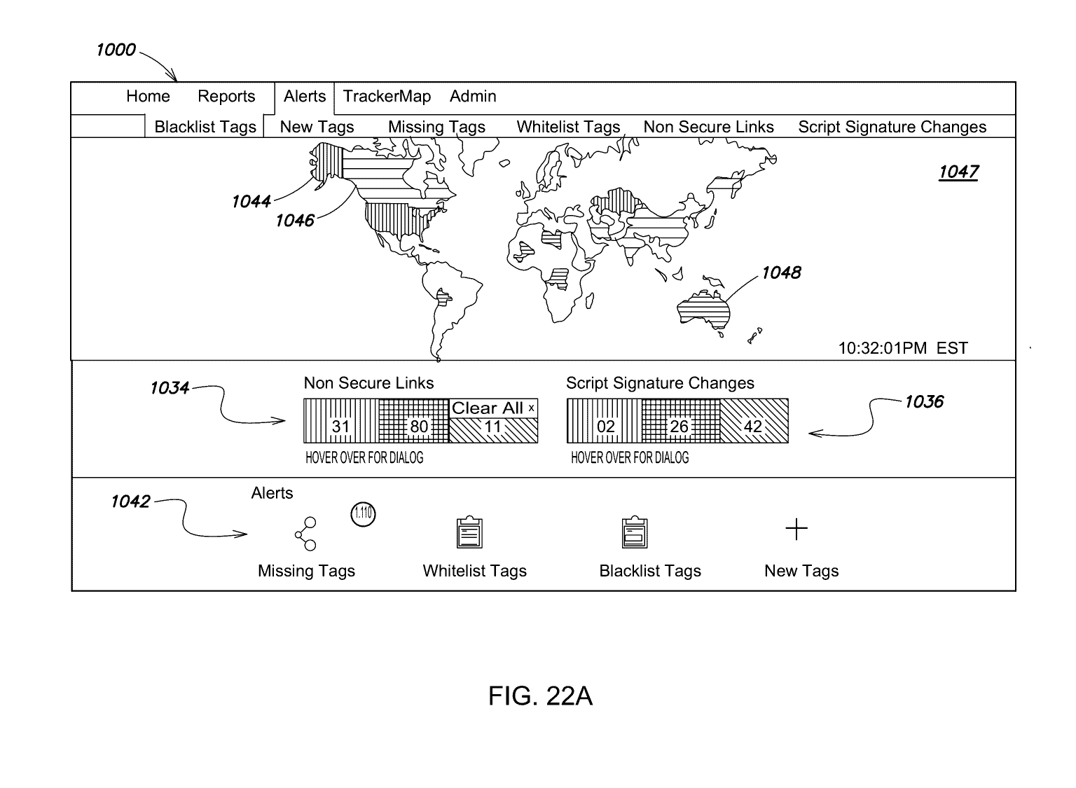

FIG. 21 illustrates a graphical user interface to create a black list alert, according to one embodiment of the present invention. In some instances, a user can configure a plurality of alerts with respect to the web resources loaded in a marketing cloud associated with a website. For example, a user can create a black list alert which will go off when an pre-specified undesired tag is encounter in a marketing cloud related to a domain, domain group and/or URL. A user can create an alert by entering an alert name in the text box 1071. The user can enter an email address into the text box 1075 of a recipient who will receive the alert when a condition is met, for example an undesired tag was encountered in a marketing cloud. The user can specify a domain by entering a domain, domain group or URL in the text box 1077. Moreover, a user can specify a monitoring frequency by entering a time interval in the drop down menu 1073. One or more tags can be associated with an alert by entering or selecting a tag in the text box 1081.

Alerts can be configured to detect a plurality of events related to a marketing cloud including but not limited to new tags, missing tags, white list tags, non-secure tags, script signatures (SS) (SS alerts monitor changes to scripts and associated risk level within a marketing cloud) and the like alerts.

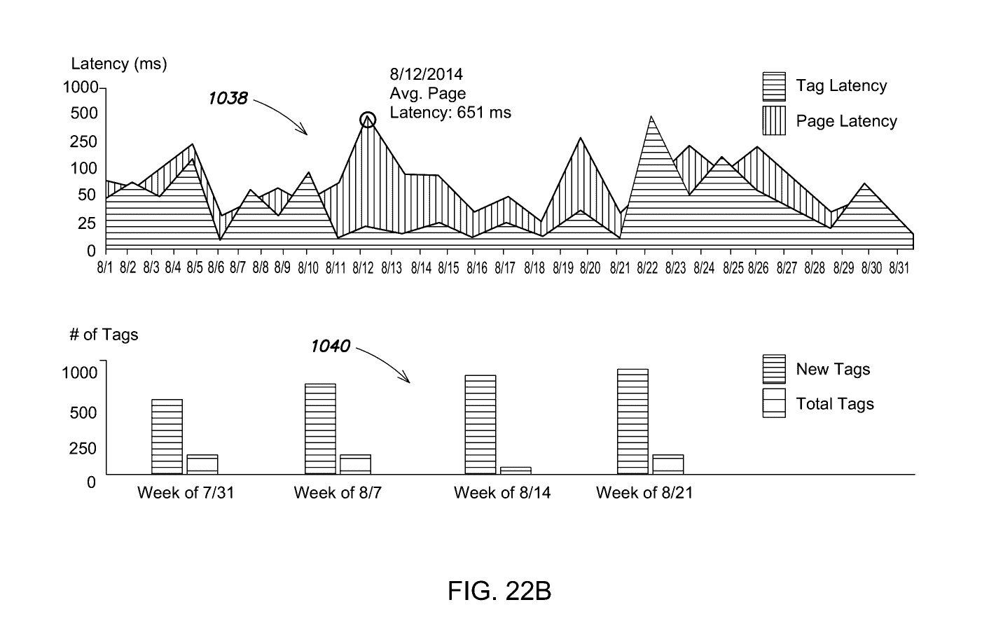

FIG. 22 illustrates a graphical user interface displaying statistical data and information associated with a web domain or website, according to one embodiment of the present invention. In some instances the graphical user interface 1000, can display a summary page including graphical information and statistical data. For example the countries in the map 1047 can be color coded to represent the performance/latency of a website when loaded from terminals in each country. For example, a country displayed in orange 1044 or red color can be interpreted as having high latency or less desirable performance while countries colored in shades of blue color (e.g., 1046 and 1048) can represent a more desirable performance, wherein a dark blue color 1048 can represent the most desirable performance.

Information about the latency of one or more type of web resources in the website can be displayed. For example, a number of non-secure links 1034 in a marketing cloud can be displayed with different background colors representing latency. The colors can be interpreted as follow: red when a non-secure the latency to load a resource through a non-secure link is above 0.7 ms, yellow when is between 0.4 ms and 0.699 ms, green when is between 0.1 ms and 0.399 ms and grey when there is no activity. Script signature changes can be displayed similarly 1036.

The graphical user interface screen shown in FIG. 20 can also include a plurality of navigation shortcut buttons 1042, enabling a user to rapidly navigate to preselected sections for example, a missing tags section, a whitelist tag section, a blacklist tag section, a new tag section and the like.

Statistical information can also be displayed for example the latency graph shown in 1038 provides information regarding average tag latencies and average page latencies. In addition the histogram 1040 can provide information about the number of tags and/or vendor tags associated with a specific website or domain.

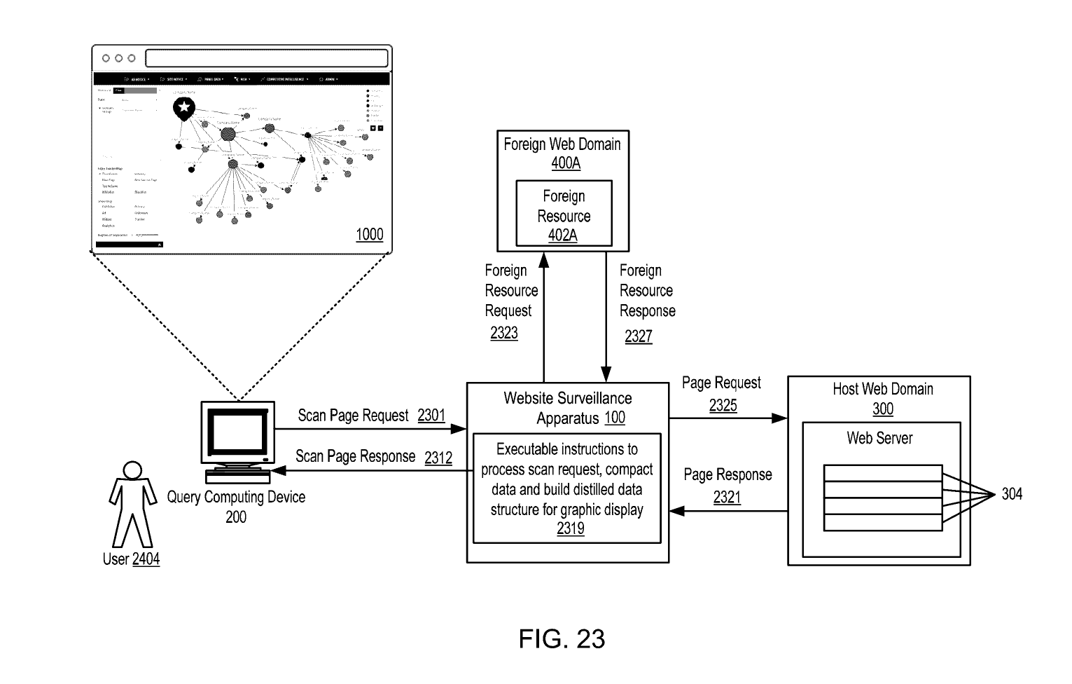

FIG. 23 illustrates a process to scan a web page to discover and display web resources associated with the web page, according to one embodiment of the present invention. In some implementations, the user 2404 can send a scan page request 2301 to the website surveillance apparatus 100. The request 2301 can include a URL, a domain name and/or other identifiers related to the web page the user 2402 is requesting to be scanned. For example, the request 2301 can include the URL “www.hostwebdomain300.com/homepage.html” corresponding to a web page hosted by the apparatus 300.

The apparatus 100 can receive the request 2301 and thereafter, via the executable instruction 2319 it can process the request, compact, compress and/or distill the data to build a data structure required by the query computing device 900 to display a “balls and sticks” type tracker map representation of the web resources associated with the web page provided in the request 2301. The processor executable instructions in 2319 can be according to the processes illustrated with respect to FIG. 7, FIG. 8 and/or FIG. 9 of this document. Accordingly, the apparatus 100 can request the electronic content 2325 corresponding to a web page, for example any of the web pages in 304, hosted by the apparatus 300. Thereafter the apparatus 100 can receive the requested electronic content via the page response 2321.

Thus, one or more HTTP requests to foreign web domains can be included in the page response 2321 and/or can be nested in one or more web resources embedded in the received electronic content 2321. Therefore, the apparatus 100 can make a foreign resource request 2323 to the foreign web domain 400A to retrieve the foreign resource 402A. Note that several foreign resource requests like the request 2323 can be made depending on the content of the response 2321 and/or any nested HTTP request included in the foreign resource 402A. These requests can be directed to the foreign web domain 400A or another foreign web domain, for example, the foreign web domain 400B as shown in FIG. 1. Thereafter, through the processor executable instruction 2319 the apparatus 100 can send a data structure with the data to render a “balls and sticks” type tracker map graphical representation as shown in the interface 1000.

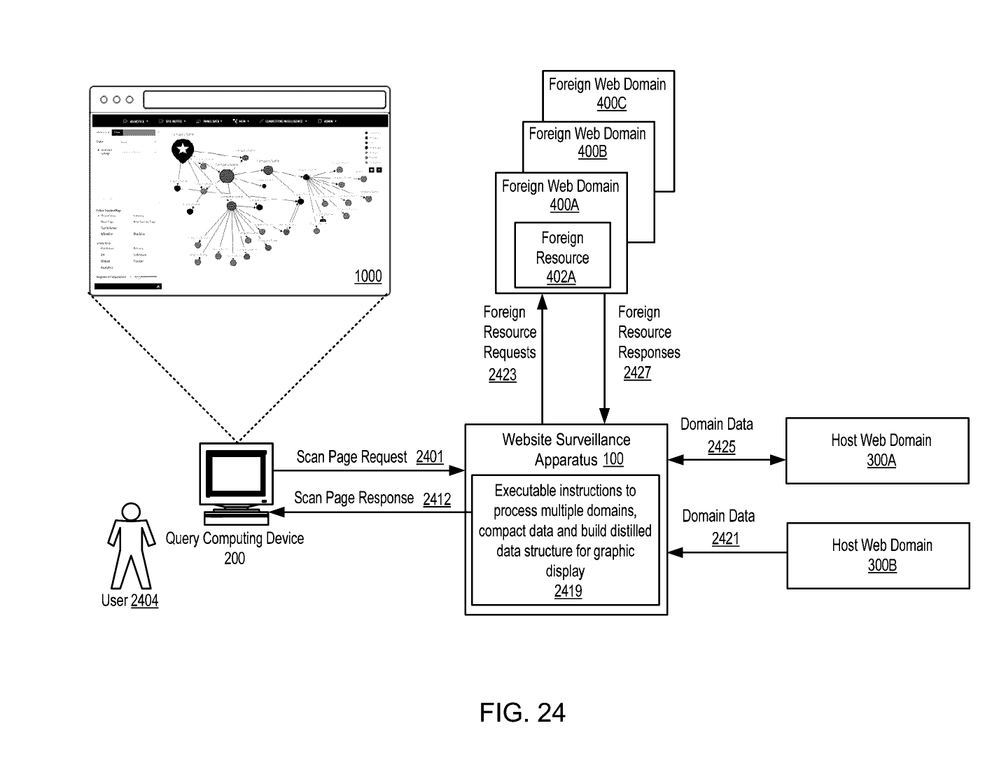

FIG. 24 illustrates a process to scan multiple domains to discover and display web resources associated with the multiple domains, according to one embodiment of the present invention. In some implementations, the user 2404 can send a request 2401 to process a set or list of domains. The list or set can include multiple domains of interest to the user 2404.

The processing of multiple domains may involve computational expensive tasks because a domain can include many web pages. Therefore, this process can be executed by the apparatus 100 on a schedule basis. Thus, the apparatus 100 can receive the request 2401 and thereafter via the processor executable instruction 2419 it can process the request, compact, compress and/or distill the data to build a data structure needed for the display of a tracker maps. Note that the domains can be processed based on a schedule, for example, weekly, daily and/or the like time intervals. The processed data can be stored in a repository, for example, the digital vendor database device 800. Accordingly, the query computing device 900 can retrieve on-demand, the pre-processed domain data to display “balls and sticks” type tracker map representations of the web resources associated with each of the web pages in the domains included in the request 2401.

The processor executable instructions in 2419 can be according to the processes illustrated with respect to FIG. 7, FIG. 8 and/or FIG. 9 of this document. Thus, the apparatus 100 can request and receive domain data 2425 and 2421 according to the predetermined schedule. The domain data 2425 and 2421 can include the electronic content corresponding to a one or more web pages associated with the domains 300A and 300B (respectively).

Note that one or more HTTP requests to foreign web domains can be included in the domain data 2425 and 2421. As aforementioned with respect to FIG. 23, these HTTP requests can also be nested in one or more web resources embedded in the received domain data or received form a foreign web domain. Therefore, the apparatus 100 can make one or more foreign resource requests 2423 to one or more foreign web domains e.g., 400A, 400B and 400C. These foreign web domains can send one or more foreign resource responses 2427. As noted, the responses 2427 can have nested HTTP requests to other foreign web domains and so on. Thereafter, once all the HTTP requests are processed through the processor executable instruction 2319 the apparatus 100 can store in the digital vendor database device 800 the data structures with the data needed by the query computing device 900 to render a “balls and sticks” type tracker map representation of each of the web pages in the domains. Accordingly, the scan domains response 2412 can be send on demand and the tracker maps of each of the domains can be display as shown in 1000.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A web site surveillance apparatus to reveal and monitor a plurality of third-party digital technology vendors providing foreign content on a client computing device pursuant to execution of at least one web page of a web site by a browser operating on the client computing device, the apparatus comprising:
at least one communication interface to communicatively couple the apparatus, via the Internet, to a host web domain hosting the web site, a plurality of foreign web domains respectively associated with the plurality of third-party vendors, and a query computing device;
at least one memory storing processor-executable instructions; and
at least one processor, communicatively coupled to the at least one communication interface and the at least one memory, wherein upon execution of the processor-executable instructions by the at least one processor, the at least one processor:
A) controls the at least one communication interface to:
A1) receive a query from the query computing device, wherein the query identifies the host web domain; and
A2) in response to the query, retrieve from the host web domain the at least one web page of the web site;
B) analyzes the retrieved at least one web page to identify a plurality of vendor tags in the at least one web page, wherein the plurality of vendor tags respectively include a corresponding redirection command, and wherein each corresponding redirection command includes a Uniform Resource Locator (URL) web address to call at least one corresponding foreign web resource in at least one of the plurality of foreign web domains;
C) identifies the plurality of third-party vendors respectively associated with the plurality of vendor tags in the at least one web page and a plurality of piggyback vendor tags associated with the plurality of vendor tags in the at least one web page, based on at least one of:
the URL web address included in each corresponding redirection command; and
the at least one corresponding foreign web resource called by, or retrieved in response to, each corresponding redirection command; and
D) controls the at least one communication interface to transmit, via the Internet to the query computing device, display-related data representing a graphical representation of the host web domain, the plurality of vendor tags identified in the at least one web page, and the plurality of piggyback vendor tags associated with the plurality of vendor tags wherein, upon processing the display-related data to render the graphical representation, the graphical representation includes:
a host web domain identifier representing the host web domain;
a plurality of vendor tag identifiers representing the plurality of vendor tags identified in the at least one web page and the plurality of piggyback vendor tags; and
a plurality of third-party vendor identifiers, graphically associated with the plurality of vendor tag identifiers and representing the plurality of third-party vendors respectively associated with the plurality of vendor tags identified in the at least one web page and the plurality of piggyback vendor tags.

2. The apparatus of claim 1, further comprising at least one user interface including a display device, communicatively coupled to the at least one processor, wherein upon execution of the processor-executable instructions the at least one processor further controls the display device to render the graphical representation on the display device.

3. The apparatus of claim 1, wherein:
the graphical representation represented by the display-related data in D) further includes a plurality of connectors;
the host web domain identifier is a host node;
the plurality of vendor tag identifiers are a plurality of vendor tag domain nodes respectively representing corresponding foreign web domains that provide the plurality of vendor tags and the plurality of piggyback vendor tags; and
the plurality of connectors interconnect the host node and the plurality of vendor tag domain nodes.

4. The apparatus of claim 3, wherein the host node and the plurality of vendor tag domain nodes have a circular shape in the graphical representation.

5. The apparatus of claim 4, wherein respective sizes of the plurality of vendor tag domain nodes represent respective prevalences of the plurality of vendor tags represented by the plurality of vendor tag domain nodes.

6. The apparatus of claim 5, wherein respective colors of the plurality of vendor tag domain nodes represent respective types of the plurality of vendor tags represented by the plurality of vendor tag domain nodes.

7. The apparatus of claim 6, wherein respective thicknesses of the plurality of connectors represent an amount of communication between the host domain and one foreign web domain of the plurality of foreign web domains, or between two foreign web domains of the plurality of foreign web domains, represented by interconnected nodes of the host node and the plurality of vendor tag domain nodes.

8. The apparatus of claim 1, wherein:
in B), the at least one processor analyzes the retrieved at least one web page to identify a first vendor tag in the at least one web page that includes a first redirection command, wherein the first redirection command includes a first URL web address to call at least one first foreign web resource in at least one of the plurality of foreign web domains;
in C), the at least one processor:
C1) executes the first redirection command and thereby controls the at least one communication interface to retrieve the first foreign web resource based on the first URL web address, wherein:
the first foreign web resource includes a first piggyback vendor tag including an additional redirection command; and
the additional redirection command includes an additional URL web address to call at least one additional foreign web resource in at least one of the plurality of foreign web domains;
C2) identifies a first third-party vendor of the plurality of third-party vendors based on at least one of the first URL web address included in the first redirection command and the first foreign web resource retrieved in C1);
C3) executes the additional redirection command in the first piggyback vendor tag and thereby controls the at least one communication interface to retrieve the additional foreign web resource based on the additional URL web address; and
C4) identifies an additional third-party vendor of the plurality of third-party vendors based on at least one of the additional URL web address included in the additional redirection command and the additional foreign web resource retrieved in C3).

9. The apparatus of claim 8, wherein the at least one processor further creates an archive file comprising:
the first URL web address;
a first latency time to retrieve the first foreign web resource;
the additional URL web address; and
a second latency time to retrieve the additional foreign web resource.

10. The apparatus of claim 9, wherein the archive file further comprises:
a first header size for the first vendor tag;
a first body size for the first vendor tag;
a second header size for the first piggyback vendor tag; and
a second body size for the first piggyback vendor tag.

11. The apparatus of claim 8, wherein in C), each vendor tag of the plurality of vendor tags and the plurality of piggyback vendor tags has a corresponding tag prevalence based at least in part on a number of times that the vendor tag is called upon execution of the at least one web page by the browser operating on the client computing device.

12. The apparatus of claim 11, wherein in the graphical representation represented by the display-related data in D):
a first vendor tag identifier of the plurality of vendor tag identifiers is associated with a corresponding first vendor tag of the plurality of vendor tags or the plurality of piggyback vendor tags;
the corresponding first vendor tag has a first tag prevalence; and
at least one first attribute of the first vendor tag identifier in the graphical representation is based at least in part on the first tag prevalence of the corresponding first vendor tag.

13. The apparatus of claim 12, wherein the at least one first attribute of the first vendor tag identifier includes at least one of:
a color of the first vendor tag identifier;
a shape of the first vendor tag identifier;
a gray-tone shade of the first vendor tag identifier;
a hatching pattern of the first vendor tag identifier;
a transparency of the first vendor tag identifier;
a size of the first vendor tag identifier; and
a position of the first vendor tag identifier in the graphical representation.

14. The apparatus of claim 8, wherein in C), each vendor tag of the plurality of vendor tags and the plurality of piggyback vendor tags has a corresponding tag classification based at least in part on a corresponding type of the foreign content that is instantiated on the client computing device upon execution of the at least one web page by the browser operating on the client computing device.

15. The apparatus of claim 14, wherein each vendor tag is classified as one of:
an advertising tag that displays advertising content in the executed at least one web page on the client computing device;
a tracker tag that instantiates a tracking digital asset on the client computing device to collect data about a user interacting with the executed at least one web page on the client computing device;
an analytics tag that instantiates an analytics digital asset on the client computing device to collect web site audience intelligence information associated with the at least one web page;
a privacy tag that instantiates a privacy digital asset to discloses and/or provide opt-out functionality to a user interacting with the executed at least one web page on the client computing device;
a widget tag that instantiates a web widget digital asset on the client computing device to provide user-facing page functionality on the executed at least one web page on the client computing device; and
an unknown tag associated with at least one third-party vendor of the plurality of third-party vendors providing the foreign content, wherein the unknown tag has an unknown function.

16. The apparatus of claim 14, wherein in C), the at least one processor further:
determines the corresponding tag classification of each vendor tag of the plurality of vendor tags and the plurality of piggyback vendor tags, based on at least one of:
the URL web address included in each redirection command; and
the at least one corresponding foreign web resource called by the URL web address.

17. The apparatus of claim 16, wherein in the graphical representation represented by the display-related data in D):
a first vendor tag identifier of the plurality of vendor tag identifiers is associated with a corresponding first vendor tag of the plurality of vendor tags or the plurality of piggyback vendor tags;
the corresponding first vendor tag has a first tag classification; and
at least one first attribute of the first vendor tag identifier in the graphical representation is based at least in part on the first tag classification of the corresponding first vendor tag.

18. The apparatus of claim 17, wherein the at least one first attribute of the first vendor tag identifier includes at least one of:
a color of the first vendor tag identifier;
a shape of the first vendor tag identifier;
a gray-tone shade of the first vendor tag identifier;
a hatching pattern of the first vendor tag identifier;
a transparency of the first vendor tag identifier;
a size of the first vendor tag identifier; and
a position of the first vendor tag identifier in the graphical representation.

19. The apparatus of claim 16, wherein in the graphical representation represented by the display-related data in D), respective attributes of the plurality of vendor tag identifiers are based at least in part on corresponding classifications of the plurality of vendor tags and the plurality of piggyback vendor tags, if any, respectively associated with the plurality of vendor tag identifiers.

20. The apparatus of claim 8, wherein the at least one processor further:
determines a first tag latency associated with a first vendor tag of at least one of the plurality of vendor tags and the plurality of piggyback vendor tags.

21. The apparatus of claim 20, wherein the at least one processor executes the first vendor tag so as to determine the first tag latency.

22. The apparatus of claim 20, wherein in the graphical representation represented by the display-related data in D):
a first vendor tag identifier of the plurality of vendor tag identifiers is associated with the first vendor tag; and
at least one second attribute of the first vendor tag identifier in the graphical representation is based at least in part on the first tag latency associated with the first vendor tag.

23. The apparatus of claim 22, wherein the at least one second attribute includes at least one of:
a color of the first vendor tag identifier;
a shape of the first vendor tag identifier;
a gray-tone shade of the first vendor tag identifier;
a hatching pattern of the first vendor tag identifier;
a transparency of the first vendor tag identifier;
a size of the first vendor tag identifier; and
a position of the first vendor tag identifier in the graphical representation.

24. The apparatus of claim 23, wherein in the graphical representation represented by the display-related data in D):
the first vendor tag has a first classification;
a color of the first vendor tag identifier in the graphical representation is based at least in part on the first classification of the first vendor tag; and
a size of the first vendor tag identifier in the graphical representation is based at least in part on the first tag latency associated with the first vendor tag.

25. The apparatus of claim 8, wherein the at least one processor further:
determines a first tag security of a first vendor tag of at least one of the plurality of vendor tags and the plurality of piggyback vendor tags, based at least in part on a secure or non-secure first URL web address in a first redirection command of the first vendor tag.

26. The apparatus of claim 25, wherein the at least one processor executes the first vendor tag so as to determine the first tag security.

27. The apparatus of claim 25, wherein in the graphical representation represented by the display-related data in D):
a first vendor tag identifier of the plurality of vendor tag identifiers is associated with the first vendor tag; and
at least one third attribute of the first vendor tag identifier in the graphical representation is based at least in part on the first tag security associated with the first vendor tag.

28. The apparatus of claim 27, wherein the at least one third attribute includes at least one of:
a color of the first vendor tag identifier;
a shape of the first vendor tag identifier;
a gray-tone shade of the first vendor tag identifier;
a hatching pattern of the first vendor tag identifier;
a transparency of the first vendor tag identifier;
a size of the first vendor tag identifier; and
a position of the first vendor tag identifier in the graphical representation.

29. The apparatus of claim 27, wherein in the graphical representation represented by the display-related data in D):
the host web domain identifier is a host node;
the plurality of vendor tag identifiers are a plurality of vendor tag nodes;
a plurality of edges couple the host node to the plurality of vendor tag nodes;
the first vendor tag identifier is a first vendor tag node of the plurality of vendor tag nodes;
the first vendor tag node is visually coupled to a first edge of the plurality of edges; and
the at least one third attribute of the first vendor tag identifier is represented by a characteristic of the first edge visually coupled to the first vendor tag node.

30. The apparatus of claim 29, wherein the at least one characteristic of the first edge is at least one of a solid line, a broken line, and a colored line.

31. The apparatus of claim 8, wherein:
the at least one web page previously was analyzed to identify a plurality of previously-identified vendor tags in the at least one web page and a plurality of previously-identified piggyback vendor tags associated with the plurality of previously-identified vendor tags; and
the at least one processor compares the plurality of vendor tags and the plurality of piggyback vendor tags to the plurality of previously-identified vendor tags and the plurality of previously-identified piggyback vendor tags so as to determine if a first vendor tag of at least one of the plurality of vendor tags and the plurality of piggyback vendor tags is a new vendor tag that was not present in the plurality of previously-identified vendor tags or the plurality of previously-identified piggyback vendor tags.

32. The apparatus of claim 31, wherein in the graphical representation represented by the display-related data in D):
a first vendor tag identifier of the plurality of vendor tag identifiers is associated with the first vendor tag; and
at least one fourth attribute of the first vendor tag identifier in the graphical representation is based at least in part on the first vendor tag being the new vendor tag.

33. A system comprising:
the web site surveillance apparatus of claim 1; and
a digital vendor database device, communicatively coupled to the at least one communication interface of the web site surveillance apparatus and storing a digital vendor database, wherein the digital vendor database comprises:
a plurality of known vendor entries respectively corresponding to a plurality of known third-party digital technology vendors;
a plurality of known tag entries respectively corresponding to a plurality of known vendor tags; and
a plurality of known URL pattern entries respectively corresponding to a plurality of known patterns in known URL web addresses that respectively correspond to the plurality of known vendor tags.

34. The system of claim 33, wherein in the digital vendor database:
each known vendor entry of the plurality of known vendor entries includes:
a vendor number code corresponding to a known third-party vendor;
a corresponding vendor name associated with the vendor number code; and
a corresponding vendor tag classification associated with the vendor number code and the corresponding vendor name;
each known tag entry of the plurality of known tag entries includes:
a tag number code corresponding to a known vendor tag; and
a corresponding vendor number code associated with the tag number code; and
each known URL pattern entry of the plurality of known URL pattern entries includes:
a URL pattern type;
at least a portion of a known URL web address to be matched, according to the URL pattern type, with at least a portion of the URL web address included in each redirection command; and
a corresponding tag number code associated with at least the portion of the known URL web address to be matched.

35. The system of claim 34, wherein the known URL web address includes a domain and a path, and wherein in the digital vendor database, the URL pattern type in each known URL pattern entry includes one of:
a host pattern type to match the domain in the known URL web address;
a host-path pattern type to match both the domain in the known URL web address and at least a first portion of the path in the known URL web address;
a path pattern type to match at least a second portion of the path in the known URL web address; and
a regular expression pattern type to match at least a first portion of the domain in the known URL web address together with at least a third portion of the path in the known URL web address.

36. The system of claim 38, wherein at least some of the plurality of known URL pattern entries in the digital vendor database are formatted as a suffix-generated trie structure based on respective subdomain parts of the domain of the known URL web addresses, so as to significantly reduce a processing time of the at least one processor in analyzing the URL web address included in each redirection command.

37. The system of claim 33, wherein for the at least one processor of the web site surveillance apparatus, in C), the at least one processor:
C1) compares at least a portion of the URL web address in each redirection command to the plurality of known URL pattern entries in the digital vendor database to determine a corresponding matching known pattern in at least the portion of the URL web address and a corresponding known vendor tag based on one known URL pattern entry of the plurality of known URL pattern entries; and
C2) determines a corresponding known third-party vendor of the plurality of third-party vendors associated with the corresponding known vendor tag based at least in part on one known tag entry of the plurality of known tag entries in the digital vendor database.

38. The system of claim 37, wherein:
C1) comprises comparing at least the portion the URL web address in each redirection command to the plurality of known URL pattern entries in the digital vendor database to determine the one known tag entry of the plurality of known tag entries that corresponds to the one known URL pattern entry of the plurality of known URL pattern entries that matches at least the portion of the URL web address; and
C2) comprises:
C2a) determining one known vendor entry that corresponds to the one known tag entry determined in C1); and
C2b) determining the corresponding known third-party vendor of the plurality of third-party vendors based on the one known vendor entry determined in C2a).

39. The system of claim 38, wherein:
each of the known URL web addresses includes a domain and a path; and
at least some of the plurality of known URL pattern entries in the digital vendor database are formatted as a suffix-generated trie structure based on subdomain parts of respective domains of the known URL web addresses, so as to significantly reduce a processing time of the at least one processor to perform C).

40. The system of claim 33, wherein for the at least one processor of the web site surveillance apparatus, in C), the at least one processor identifies a first third-party vendor associated with a first piggyback vendor tag based at least in part on a first foreign web resource called by, or received in response to, a first URL web address in the first piggyback vendor tag.

41. The system of claim 40, wherein:
the first piggyback vendor tag is a parent resource of the first foreign web resource;
the first foreign web resource is a child resource of the first piggyback vendor tag; and
the first piggyback vendor tag is identified as the parent resource based at least in part on at least one weighted match between at least a first portion of the parent resource and at least a first portion of the child resource.

42. The system of claim 41, wherein:
the parent resource includes a parent header, the first URL web address, and a parent body;
the child resource includes a child header; and
the at least one weighted match is based at least in part on at least one of:
the child header including a parent URL web address for the parent resource;
the parent body including a child URL web address for the child resource;
the child header including a first web domain name for the parent resource;
the parent body including a second web domain name for the child resource;
the parent resource including a path portion of the child URL web address;
the parent resource including the second web domain name for the child resource; and
the parent resource including a fragment of the second web domain name for the child resource.

43. A web site surveillance apparatus to reveal and monitor a plurality of third-party digital technology vendors providing foreign content on a client computing device pursuant to execution of at least one web page of a web site by a browser operating on the client computing device, the apparatus comprising:
at least one communication interface to communicatively couple the apparatus, via the Internet, to a host web domain hosting the web site and a plurality of foreign web domains respectively associated with the plurality of third-party vendors;
at least one user interface including a display device;
at least one memory storing processor-executable instructions; and
at least one processor, communicatively coupled to the at least one communication interface, the at least one user interface, and the at least one memory, wherein upon execution of the processor-executable instructions by the at least one processor, the at least one processor:
A) controls the at least one communication interface to retrieve from the host web domain the at least one web page of the web site;
B) analyzes the retrieved at least one web page to identify a first vendor tag in the at least one web page that includes a first redirection command, wherein the first redirection command includes a first Uniform Resource Locator (URL) web address to call at least one first foreign web resource in at least one of the plurality of foreign web domains;
C) executes the first redirection command and thereby controls the at least one communication interface to retrieve the first foreign web resource based on the first URL web address, wherein:
the first foreign web resource includes an additional redirection command; and
the additional redirection command includes an additional URL web address to call at least one additional foreign web resource in at least one of the plurality of foreign web domains;
D) identifies a first third-party vendor of the plurality of third-party vendors and associated with the first vendor tag based on at least one of the first URL web address included in the first redirection command and the first foreign web resource;
E) executes the additional redirection command in the first foreign web resource and thereby controls the at least one communication interface to retrieve the additional foreign web resource based on the additional URL web address; and
F) identifies an additional third-party vendor of the plurality of third-party vendors based on at least one of the additional URL web address included in the additional redirection command and the additional foreign web resource.

44. The apparatus of claim 43, wherein the at least one processor further:
G) controls the display device to render a graphical representation of the host web domain and the plurality of vendor tags identified in the at least one web page, wherein the graphical representation includes:
a host web domain identifier representing the host web domain;
a plurality of vendor tag identifiers representing the plurality of vendor tags; and
a plurality of third-party vendor identifiers, graphically associated with the plurality of vendor tag identifiers and representing the plurality of third-party vendors respectively associated with the plurality of vendor tags, wherein the plurality of third-party vendors includes at least the first third-party vendor and the additional third-party vendor.

45.-83. (canceled)

84. A computer-facilitated method for revealing and monitoring a plurality of third-party digital technology vendors providing foreign content on a client computing device pursuant to execution of at least one web page of a web site by a browser operating on the client computing device, the method comprising:
A) electronically analyzing the at least one web page to identify a plurality of vendor tags in the at least one web page, wherein the plurality of vendor tags respectively include a corresponding redirection command, and wherein each corresponding redirection command includes a Uniform Resource Locator web address to call at least one corresponding foreign web resource in at least one foreign web domain of a plurality of foreign web domains;
B) electronically identifying a plurality of third-party vendors respectively associated with the plurality of vendor tags in the at least one web page and a plurality of piggyback vendor tags associated with the plurality of vendor tags in the at least one web page, based on at least one of:
the URL web address included in each corresponding redirection command; and
the at least one corresponding foreign web resource called by, or retrieved in response to, each corresponding redirection command; and
C) electronically transmitting display-related data representing a graphical representation of a host web domain hosting the web site, the plurality of vendor tags identified in the at least one web page, and the plurality of piggyback vendor tags associated with the plurality of vendor tags wherein, upon processing the display-related data to render the graphical representation, the graphical representation includes:
a host web domain identifier representing the host web domain;
a plurality of vendor tag identifiers representing the plurality of vendor tags identified in the at least one web page and the plurality of piggyback vendor tags; and
a plurality of third-party vendor identifiers, graphically associated with the plurality of vendor tag identifiers and representing the plurality of third-party vendors respectively associated with the plurality of vendor tags identified in the at least one web page and the plurality of piggyback vendor tags.
